(19) United States
(12) Patent Application Publication
(10) Pub. No.: US 2009/0046566 A1
(43) Pub. Date: Feb. 19, 2009

(54) RECORDING LAYER FOR OPTICAL INFORMATION RECORDING MEDIUM, OPTICAL INFORMATION RECORDING MEDIUM, AND SPUTTERING TARGET FOR OPTICAL INFORMATION RECORDING MEDIUM

(75) Inventors: Hideo Fujii, Hyogo (JP); Tatewaki Ido, Hyogo (JP); Yuki Tauchi, Hyogo (JP); Naokazu Sakoda, Hyogo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel Ltd.), Kobe-shi (JP)

(21) Appl. No.: 12/090,569

(22) PCT Filed: Oct. 17, 2006
(86) PCT No.: PCT/JP2006/320678

§ 371 Date: Apr. 17, 2008

(30) Foreign Application Priority Data
Oct. 18, 2005 (JP) 2005-303211
Oct. 28, 2005 (JP) 2005-315411
Dec. 27, 2005 (JP) 2005-376059
Jan. 11, 2006 (JP) 2006-004099
Jan. 27, 2006 (JP) 2006-019208

(51) Int. Cl. G11B 7/26

(52) U.S. Cl. 369/283; G9B/7.194

(57) ABSTRACT

Provided is a recording layer for optical information storage media, which not only excels in initial reflectivity and creativity of recording marks, but also extremely excels in durability under high temperature and high humidity conditions, and which can be adequately applied to next-generation optical discs using blue-violet laser. The recording layer for optical information storage media is a recording layer to create recording marks upon irradiation with a laser beam. This recording layer is composed of a tin-based alloy containing a total of 1.0 atomic percent or more and 15 atomic percent or less of at least one selected from neodymium (Nd), gadolinium (Gd), and lanthanum (La).

### TECHNICAL FIELD

The present invention relates to recording layers and sputtering targets for optical information storage media, as well as optical information storage media using the same. The recording layers for optical information storage media according to the present invention can be used not only for current compact discs (CDs) and digital versatile discs (DVDs) but also for next-generation optical information storage media such as HD DVDs and Blu-ray Discs, and suitably used for write-once optical information storage media, particularly for optical information storage media using blue-violet laser.

### BACKGROUND ART

Optical information storage media (optical discs) are roughly categorized by the writing and reading system into three main types, i.e., read-only, rewritable, and write-once optical discs.

In write-once optical discs among these discs, data is recorded by principally utilizing changes in properties of material in the recording layer irradiated with a laser beam. The name of optical discs of this type, write-once optical discs, originates from the fact that data can be recorded but neither erased nor rewritten. The write-once optical discs are widely used to prevent tampering of data such as text files and image files using these properties, and examples thereof include CD-R, DVD-R, and DVD+R discs.

Materials for the recording layer used for the write-once optical discs include organic dye materials such as cyanine dyes, phthalocyanine dyes, and azo dyes. When irradiated with a laser beam, an organic dye material absorbs heat, and the dye and/or a substrate decomposes, melts, and/or evaporates to thereby create a recording mark. However, organic dye materials, if used, must be dissolved in organic solvents before coated on a substrate, which results in reduction in productivity. In addition, organic dye materials are insufficient in storage stability of recorded signals.

As a possible solution to this, there has been proposed a technique of carrying out recording, in which a thin film of an inorganic material is used as a recording layer instead of an organic dye material, and this thin film is irradiated with a laser beam to create holes (recording marks) or deformations (pits) (hereinafter also referred to as “hole creating recording system”).

Appl. Phys. Lett., 34 (1979), 835, for example, discloses a technique in which holes are created by a laser beam at a low laser power using a thin film of tellurium (Te) that has a low melting point and a low thermal conductivity.

Japanese Unexamined Patent Application Publication (JP-A) No. 2004-5922 (Patent Document 1) and JP-A No. 2004-234717 (Patent Document 2) disclose multilayer recording layers each consisting of a reactive layer containing a copper-based (Cu-based) alloy containing aluminum (Al), and another reactive layer containing, for example, silicon (Si). A region where atoms contained in each reaction layer are mixed is partially formed on a substrate upon irradiation with a laser beam, and reflectivity in that region is greatly changed; therefore, information can be recorded with high sensitivity even if a laser beam having a short wavelength, such as a blue laser beam, is used.

JP-A No. 2002-172861 (Patent Document 3), JP-A No. 2002-144730 (Patent Document 4), and JP-A No. 2002-225433 (Patent Document 5) relate to techniques on optical storage media using the hole creating recording system, to prevent reduction in C/N ratio (carrier to noise ratio in output) and to exhibit a high C/N ratio and a high reflectivity. The recording layers in these media use a copper-based (Cu-based) alloy containing indium (In) (Patent Document 3), a silver-based (Ag-based) alloy typically containing bismuth (Bi) (Patent Document 4), and a tin-based alloy typically containing bismuth (Patent Document 5), respectively.

JP-A No. Hei 2-117887 (Patent Document 6), JP-A No. 2001-180114 (Patent Document 7), and JP-A No. 2004-90610 (Patent Document 8), as well as above-mentioned JP-A No. 2002-225433 (Patent Document 5) relate to tin-based alloys. Patent Document 6 relates to optical storage media containing two or more different atoms in a metal alloy layer, which atoms can at least partially aggregate upon heat treatment. Specifically, this document discloses, for example, a tin-copper-based alloy layer having a thickness of 1 to 8 nm and containing bismuth and indium, and mentions that this configuration enables a storage medium with a high melting point and a high thermal conductivity. Patent Document 7 discloses a recording layer containing a tin-bismuth alloy having excellent recording properties in combination with a material more susceptible to oxidation than tin and bismuth. This technique yields an optical storage medium having enhanced durability when the medium is maintained under high temperature and high humidity conditions such as a temperature of 60° C. and relative humidity of 90% for 120 hours. Patent Document 8 discloses an optical storage medium having an optical recording layer containing a compound with a specific component of SnₓN_{y}O_{z}, wherein “x”, “y”, and “z” are each atomic percent and satisfy the following conditions: 30<x<70, 1<y<20, and 20<z<60. Patent Document 8 mentions that this technique solves problems occurring when recording of information is carried out using tin as a recording material by irradiation with a laser beam having a short wavelength of about 380 to 420 nm through an objective lens with a numerical aperture of about 0.8. Specifically, in the recording of this type, satisfactory recording marks are not formed, and a jitter increases.

### DISCLOSURE OF INVENTION

As the demand for high-density information recording grows more and more, it is desired to carry out recording and reading of information using particularly a short-wavelength laser beam such as a blue-violet laser beam. Although the known techniques of recording information using the hole creating recording system improve recording properties such as low thermal conductivity, high initial reflectivity, and good creation of recording marks, durability of optical storage media is still poor under high temperature and high humidity conditions.

The recording layers for optical information storage media also suffer from a low C/N ratio as is mentioned above, in addition to poor durability under high temperature and high humidity conditions.

Although metallic optical information recording layers are superior in storage stability of recorded information over long period to organic optical recording layers as described above, the metallic recording layers gradually deteriorate in writing and reading properties from further longer-time viewpoint, because the layers are oxidized by oxygen and/or water (moisture) in the atmosphere that passes through resinous discs.

Recording layers for optical information storage media (optical recording layers) should have various properties such as (1) high-quality writing and reading of signals, such as high C/N ratio (i.e., high (strong) readout signals and low background noise) and low jitter (i.e., readout signals less fluctuate on the time base), (2) high recording sensitivity (signals are writable with a laser beam at a low power), (3) high reflectivity of the recording layers, so as to provide stable tracking, and (4) high corrosion resistance.

After investigations, however the present inventors found that the metal recording layers according to the known techniques of forming recording marks do not satisfy all these requirements or do not sufficiently satisfy all these requirements. Accordingly, they are insufficient in practical use. Metallic recording layers, however, are still significantly advantageous in that their materials are further more stable than those in organic recording layers. It is therefore desirable to develop a practical recording layer satisfying the above-mentioned requirements using a metal material. This will provide BD-R and HD DVD-R discs as highly reliable optical information recording media.

Sputtering is desirably employed in deposition of optical recording layers, for high production efficiency. It is therefore desirable to provide a sputtering target for the deposition of a high-quality optical recording layer; and an optical information storage medium including the recording layer.

The present invention has been made under these circumstances, and a first object of the present invention is to provide a recording layer for optical information storage media, a sputtering target containing materials for the deposition of the recording layer, and an optical information storage medium provided with the recording layer, which recording layer is not only excellent in initial reflectivity and creativity of recording marks but also extremely excellent in durability under high temperature and high humidity conditions and which can be adequately applied to next-generation optical discs using blue-violet laser beams.

A second object of the present invention is to provide a recording layer for optical information storage media, a sputtering target containing materials for the deposition of the recording layer, and an optical information storage medium provided with the recording layer, which recording layer not only excels in recording properties such as initial reflectivity and creativity of recording marks but also has a high C/N ratio (specifically, low noise), shows good durability even under high temperature and high humidity conditions, and which can be adequately applied to next-generation optical discs using blue-violet laser beams.

A third object of the present invention is to provide an optical information recording layer, an optical information storage medium provided with the recording layer, and a sputtering target useful for the deposition of the optical information recording layer, which recording layer is formed from a metallic material, not only satisfies requirements such as the above-mentioned properties (1) to (4), but also can reliably carry out recording of information with good sensitivity and is inexpensive in cost.

The above objects has been achieved by the present invention. Specifically, there is provided a recording layer for optical information storage media to create recording marks upon irradiation with a laser beam, according to a first embodiment of the present invention. The recording layer is composed of a tin-based (Sn-based) alloy containing a total of 1.0 atomic percent or more and 15 atomic percent or less of at least one selected from the group consisting of neodymium (Nd), gadolinium (Gd), and lanthanum (La).

In a preferred embodiment, the recording layer has a thickness in the range of 10 nm to 50 nm.

In a preferred embodiment, the laser beam has a wavelength in the range of 380 nm to 450 nm.

There is also provided a sputtering target for optical information storage media according to a first embodiment of the present invention. The sputtering target includes a tin-based alloy containing a total of 1.0 atomic percent to 15 atomic percent of at least one selected from the group consisting of neodymium (Nd), gadolinium (Gd), and lanthanum (La).

The recording layers for optical information storage media according to the first embodiment of the present invention have the above configuration, and optical information storage media provided with the recording layers are not only excellent in recording properties such as initial reflectivity and creativity of recording marks but also extremely excellent in durability under high temperature and high humidity conditions. The recording layers according to the first embodiment of the present invention can be suitably used for write-once optical discs on which recording and reading of information can be performed at high density as well as at high speed, and particularly suitably used for next-generation optical discs using blue-violet laser beams.

There is provided a recording layer for optical information storage media to create recording marks upon irradiation with a laser beam, according to a second embodiment of the present invention. This recording layer includes a tin-based alloy containing 1 atomic percent to 30 atomic percent of boron (B).

In a preferred embodiment, the recording layer further contains 50 atomic percent or less (exclusive of 0 atomic percent) of indium (In). The recording layer more preferably contains 5 atomic percent or more and 50 atomic percent or less of indium in order to further improve durability under high temperature and high humidity conditions.

In a preferred embodiment, the recording layer further contains a total of 15 atomic percent or less (exclusive of 0 atomic percent) of at least one selected from the group consisting of yttrium (Y), lanthanum (La), neodymium (Nd), and gadolinium (Gd). In a more preferred embodiment, the recording layer contains a total of 1.0 atomic percent or more and 15 atomic percent or less of at least one of these elements in order to further improve durability under high temperature and high humidity conditions.

In a preferred embodiment, the laser beam has a wavelength in the range of 380 nm to 450 nm.

There is also provided a sputtering target for optical information storage media according to still another embodiment of the present invention. This sputtering target includes a tin-based alloy containing 1 atomic percent to 30 atomic percent of boron (B).

In a preferred embodiment, the sputtering target further contains 50 atomic percent or less (exclusive of 0 atomic percent) of indium.

In another preferred embodiment, the sputtering target further contains a total of 15 atomic percent or less (exclusive of 0 atomic percent) of at least one selected from the group consisting of yttrium (Y), lanthanum (La), neodymium (Nd), and gadolinium (Gd).

There is also provided an optical information storage medium according to the second embodiment of the present invention, which includes any of the recording layers for optical information storage media according to the second embodiment of the present invention.

The recording layers for optical information storage media according to the second embodiment of the present invention have the above configuration, and an optical information storage media including the recording layers excel in recording properties such as initial reflectivity and creativity of recording marks and have a high C/N ratio. The recording layer in a preferred embodiment has improved durability under high temperature and high humidity conditions. The recording layers according to the second embodiment of the present invention can be suitably used for write-once optical discs on which recording and reading of information can be performed at high density as well as at high speed, and particularly suitably used for next-generation optical discs using blue-violet laser beams.

According to a third embodiment of the present invention, there is provided a recording layer for optical information storage to create recording marks upon irradiation with a laser beam, in which the recording layer includes a tin-based alloy containing a total of 1 atomic percent to 50 atomic percent of nickel (Ni) and/or cobalt (Co).

In a preferred embodiment, the recording layer further contains, as additional element(s), a total of 30 atomic percent or less (exclusive of 0 atomic percent) of at least one selected from the group consisting of indium (In), bismuth (Bi), and zinc (Zn). This will suppress deterioration in properties of the recording layer caused by oxidation. In another preferred embodiment, the recording layer further contains, as additional element(s), a total of 10 atomic percent or less (exclusive of 0 atomic percent) of at least one rare-earth element. The resulting recording layer can have more excellent surface smoothness and can create recording marks having more satisfactory shapes.

The recording layers according to the third embodiment of the present invention show a high recording sensitivity and exhibits excellent properties in writing and reading of optical information particularly upon irradiation with a laser beam having a wavelength in the range of 350 nm to 700 nm.

There is also provided an optical information storage medium which includes the optical recording layer according to the third embodiment having the above configuration. In a preferred embodiment, the medium further includes at least one of an optical control layer and a dielectric layer as an upper layer and/or an underlayer of the recording layer. The thickness of the optical recording layer in the optical information storage medium is preferably in the range of 1 to 50 nm when such an optical recording layer and/or a dielectric layer is arranged as an upper layer and/or an underlayer of the optical recording layer. The thickness is preferably in the range of 8 to 50 μm when neither one of them is arranged.

According to a third embodiment of the present invention, there is provided a sputtering target for the deposition of the optical recording layer by sputtering. The sputtering target includes (a) a tin-based alloy containing nickel (Ni) and/or cobalt (Co), (b) the tin-based alloy further containing a total of 30 atomic percent or less (exclusive of 0 atomic percent) of at least one selected from indium (In), bismuth (Bi), and zinc (Zn), or (c) the tin-based alloy further containing, as additional element(s), a total of 10 atomic percent or less (exclusive of 0 atomic percent) of at least one rare-earth element.

In a tin-based alloy for use in the present invention, tin (Sn) basically carries major characteristic properties of the tin-based alloy, and the tin content of the tin-based alloy is preferably 40 atomic percent or more, more preferably 50 atomic percent or more, and further preferably 60 atomic percent or more. The total content of nickel (Ni) and/or cobalt (Co) is preferably 1 to 50 atomic percent, more preferably 5 atomic percent or more and 35 atomic percent or less, and further preferably 15 atomic percent or more and 25 atomic percent or less.

In an embodiment, the tin-based alloy further contains, as additional element(s), 30 atomic percent or less (exclusive of 0 atomic percent) of at least one of indium (In), bismuth (Bi), and zinc (Zn). In addition to or instead of these elements, the tin-based alloy may further contain any metal element that is more susceptible to oxidation than tin.

In another embodiment, the tin-based alloy further contains, as additional element(s), a total of 10 atomic percent or less (exclusive of 0 atomic percent) of at least one rare-earth element. Examples of rare-earth elements include yttrium (Y), neodymium (Nd), and lanthanum (La). Each of these elements may be contained alone or in combination in the tin-based alloy.

The recording layers for optical information storage media according to the third embodiment of the present invention have the above configuration. Tin (Sn) as a base material of the tin-based alloy has a low melting point and makes it possible to create recording marks upon irradiation with a laser beam even at a low power. Since the tin-based alloy further contains suitable amounts of nickel (Ni) and/or cobalt (Co), the recording layers have an improved C/N ratio, reflectivity, and corrosion resistance and shows reduced jitter. In addition, nickel (Ni) and/or cobalt (Co) further acts to reduce the surface roughness of the optical recording layers, to create recording marks having suitable dimensions, and to effectively reduce the jitter.

The elements indium (In), bismuth (Bi), and zinc (Zn) which maybe further contained in the tin-based alloy are more susceptible to oxidation than tin and effectively act to prevent deterioration in properties of the optical recording layer caused by oxidation of tin.

The rare-earth elements which may be further contained in the tin-based alloy contribute to improvements of the corrosion resistance of the optical recording layer, effectively act to improve the surface smoothness of the recording layer and to create recording marks having suitable dimensions, and as a result, exhibit excellent effects in reduction of jitter.

According to a fourth embodiment of the present invention, there is also provided an optical information storage medium which includes a substrate and a recording layer (recording layer according to the fourth embodiment) to create recording marks upon irradiation with a laser beam, in which the recording layer includes a tin-based alloy containing 1 atomic percent to 15 atomic percent of at least one rare-earth element, and the optical information storage medium further includes a protective layer adjacent to a side of the recording layer facing the substrate and/or adjacent to the other side of the recording layer opposite to the substrate.

The tin-based alloy constituting the recording layer preferably further contains a total of 50 atomic percent or less (exclusive of 0 atomic percent) of indium (In) and/or bismuth (Bi), because deterioration caused by oxidation of tin that plays a major role in the recording layer is suppressed, and the durability of the recording layer is improved. The recording layer preferably has a thickness of 1 to 50 nm. The recording layer shows a high recording sensitivity particularly upon irradiation with a laser beam having a wavelength in the range of 350 nm to 700 nm, and the resulting optical information storage medium exhibits excellent properties in writing and reading of optical information.

There is further provided a sputtering target for the deposition of the optical recording layer by sputtering, according to a fourth embodiment of the present invention. The sputtering target contains a tin-based alloy containing a total of 1 atomic percent to 15 atomic percent of at least one rare-earth element. In another embodiment, the tin-based alloy further contains a total of 50 atomic percent or less (exclusive of 0 atomic percent) of indium (In) and/or bismuth (Bi).

In a tin-based alloy for use in the present invention, tin (Sn) basically carries major characteristic properties of the tin-based alloy, and the tin content of the tin-based alloy is preferably 40 atomic percent or more, more preferably 50 atomic percent or more, and further preferably 60 atomic percent or more. The total content of rare-earth elements is preferably 1 atomic percent to 15 atomic percent. Examples of the rare-earth elements include yttrium (Y), neodymium (Nd), lanthanum (La), gadolinium (Gd), and dysprosium (Dy).

In another embodiment, the tin-based alloy further contains, as additional element(s), a total of 50 atomic percent or less (exclusive of 0 atomic percent) of indium (In) and/or bismuth (Bi). In addition to or instead of these elements, the tin-based alloy may further contain any metal element that is more susceptible to oxidation than tin.

In the tin-based alloy constituting the recording layer of the optical information storage medium according to the fourth embodiment of the present invention, tin as a matrix has a low melting point and makes it possible to create recording marks upon irradiation with a laser beam even at a low power. In addition, a suitable amount of rare-earth element(s) contained therein contributes to improvements in corrosion resistance of the recording layer, effectively acts to improve the surface smoothness of the recording layer and to create recording marks having suitable dimensions, and, as a result, exhibits excellent effects typically in reduction of jitter (shaping of readout waveform). When the tin-based alloy further contains, as additional element(s), indium (In) and/or bismuth (Bi), the resulting recording layer can have significantly increased resistance to environmental deterioration without reducing the reflectivity thereof. This is probably because indium and bismuth are more susceptible to oxidation and form more stable oxides than tin and act to prevent deterioration in properties of the recording layer caused by oxidation of tin.

According a fifth embodiment of the present invention, there is provided a recording layer for optical information storage to create recording marks upon irradiation with a laser beam, in which the recording layer includes a tin-based alloy containing a total of 2 atomic percent to 30 atomic percent of at least one element selected from the group consisting of elements belonging to Groups 4a, 5a, 6a, and 7a of the Periodic Table of Elements, and platinum (Pt), dysprosium (Dy), samarium (Sm), and cerium (Ce).

In a preferred embodiment as recommended herein, the optical recording layer according to the present invention further contains, as additional element (s), a total of 10 atomic percent or less (exclusive of 0 atomic percent) of neodymium (Nd) and/or yttrium (Y). This recording layer has higher corrosion resistance, shows more excellent surface smoothness, can create recording marks having more satisfactory shapes, and shows further reduced jitter.

The recording layer according to the fifth embodiment of the present invention shows a high recording sensitivity and exhibits excellent properties in writing and reading of optical information, particularly upon irradiation with a laser beam having a wavelength in the range of 350 nm to 700 nm.

There is also provided an optical information storage medium according to another embodiment of the present invention, which includes the optical recording layer having the above configuration. In a preferred embodiment, the medium further includes at least one of an optical control layer and a dielectric layer as an upper layer and/or an underlayer of the recording layer. The thickness of the optical recording layer in the optical information storage medium is preferably in the range of 1 to 50 nm when an optical recording layer and/or a dielectric layer is arranged as an upper layer and/or an underlayer of the recording layer. The thickness is preferably in the range of 8 to 50 nm when neither one of them is arranged.

There is also provided a sputtering target according to a fifth embodiment of the present invention, which is a target for the deposition of the optical recording layer by sputtering. The target includes (a) a tin-based alloy containing a total of 2 atomic percent to 30 atomic percent of elements belonging to Groups 4a, 5a, 6a, and 7a of the Periodic Table of Elements, and platinum (Pt), dysprosium (Dy), samarium (Sm), and cerium (Ce), or (b) the tin-based alloy further containing a total of 10 atomic percent or less (exclusive of 0 atomic percent) of neodymium (Nd) and/or yttrium (Y).

In the tin-based alloy, tin (Sn) basically carries major properties of the tin-based alloy, and the tin content of the tin-based alloy is preferably 40 atomic percent or more, more preferably 50 atomic percent or more, and further preferably 60 atomic percent or more. The total content of at least one element selected from the group consisting of elements belonging to Groups 4a, 5a, 6a, and 7a of the Periodic Table of Elements, and platinum (Pt), dysprosium (Dy), samarium (Sm), and cerium (Ce) is preferably 2 atomic percent to 30 atomic percent, more preferably 5 atomic percent or more and 25 atomic percent or less, and further preferably 10 atomic percent or more and 20 atomic percent or less.

In an embodiment, the tin-based alloy further contains, as additional element(s), 10 atomic percent or less (exclusive of 0 atomic percent) of neodymium (Nd) and/or yttrium (Y). In addition to or instead of these elements, the tin-based alloy may further contain any metal element that is more susceptible to oxidation than tin.

In the tin-based alloy for use in the recording layer for optical information storage media according to the fifth embodiment of the present invention, tin (Sn) as a matrix has a low melting point and makes it possible to create recording marks upon irradiation with a laser beam even at a low power. In addition, the elements belonging to Groups 4a, 5a, 6a, and 7a of the Periodic Table of Elements, and Dy, Sm, and Ce are more susceptible to oxidation than tin, and the additional elements are oxidized to form a dense oxide film on the surface of the recording layer composed of the tin-based alloy, and this suppresses the oxidation of the recording layer, improves corrosion resistance, and retains over long period of time high reflectivity which the tin-based alloy originally possesses. In addition, these elements effectively retain surface smoothness of the entire recording layer composed of the tin-based alloy, because they have melting points higher than that of tin.

Among the above-mentioned elements, platinum (Pt) is more resistant to oxidation than tin, and oxygen and moisture passing through a resinous substrate and/or a cover layer initially oxidize tin prior to platinum. Platinum, however, disperses into the recording layer composed of the tin-based alloy when the layer is deposited by sputtering. This prevents diffusion of tin atoms in a surface direction, suppresses further growth of a tin oxide film, and thus contributes to improvement of corrosion resistance. As compared at the same content relative to tin as a main component, a recording layer containing platinum in a tin-based alloy shows slightly inferior corrosion resistance to a recording layer containing another element which is more susceptible to oxidation than platinum, but shows significantly higher corrosion resistance than a recording layer containing tin alone. In addition, it has been verified that an optical recording layer further containing platinum has improved surface smoothness than a recording layer further containing another element that is more susceptible to oxidation.

In addition to these elements, the recording layer preferably further contains suitable amounts of neodymium (Nd) and/or yttrium (Y). This further improves corrosion resistance of the recording layer, improves surface smoothness, effectively creates recording marks having suitable dimensions, and, in addition, effectively reduces jitter.

### BRIEF DESCRIPTION OF DRAWINGS

FIG. 1 is a cross-sectional view schematically illustrating the configuration of an embodiment of optical information storage media according to the first, second, and fourth embodiments of the present invention.

FIG. 2 depicts photographs showing surface properties (average grain diameter and surface roughness Ra) of Sn—B alloy thin films relating to Samples 1, 5, and 6 in Experimental Examples relating to the optical information storage media according to the second embodiment of the present invention, in which FIG. 2(a) depicts scanning electron microscope (SEM) images of the Sn—B alloy thin films, and FIG. 2(b) depicts atomic force microscope (AFM) images of the Sn—B alloy thin films.

FIG. 3 depicts schematic cross-sectional views showing embodiments of the optical information storage media according to the third and fifth embodiments of the present invention.

FIG. 4 depicts schematic cross-sectional views showing other embodiments of the optical information storage media according to the third and fifth embodiments of the present invention.

FIG. 5 depicts schematic cross-sectional views showing yet other embodiments of the optical information storage media according to the third and fifth embodiments of the present invention.

FIG. 6 depicts schematic cross-sectional views showing still other embodiments of the optical information storage media according to the third and fifth embodiments of the present invention.

### BEST MODES FOR CARRYING OUT THE INVENTION

The recording layers for optical information storage media, optical information storage media, and sputtering targets according to first, second, third, fourth, and fifth embodiments of the present invention will be illustrated in detail below.

Recording Layer for Optical Information Storage Media According to First Embodiment of the Present Invention

The recording layer for optical information storage media according to the first embodiment of the present invention is a recording layer to create recording marks upon irradiation with a laser beam. The recording layer includes a tin-based alloy containing a total of 1.0 atomic percent to 15 atomic percent of at least one selected from the group consisting of neodymium (Nd), gadolinium (Gd), and lanthanum (La).

The present inventors made intensive investigations focusing on tin-based alloys, in order to provide a recording layer on which information can be recorded by a hole creating recording system, and which is extremely excellent in durability (less reduction in reflectivity) under high temperature and high humidity conditions. As a result, they have found that the objects can be achieved by using a tin-based alloy containing tin and a specific amount of at least one selected from the group consisting of neodymium (Nd), gadolinium (Gd), and lanthanum (La). An embodiment of the present invention has been made based on these findings.

Initially, how the present inventors have achieved this embodiment of the present invention will be explained.

The reason why the present inventors focused on tin-based alloys is as follows. Tin (Sn) is inferior in reflectivity to aluminum (Al), silver (Ag), and copper (Cu), but it is superior in creativity of recording marks upon irradiation with a laser beam. This is probably because the melting point of tin is about 232° C. and is significantly lower than those of aluminum (about 660° C.), silver (about 962° C.), and copper (about 1085° C.); when used as a recording layer, a thin film of tin-based alloy containing tin and one or more alloy elements readily melts upon irradiation with a laser beam to thereby provide excellent recording properties. In addition, when used in a recording layer mainly aiming to be applied to next-generation optical discs using blue-violet laser as in the present invention, aluminum (Al), for example, may fail to create recording marks easily. Thus, tin-based alloys are selected in the present invention.

The criterion of durability employed herein is defined as a condition that “the change in reflectivity is less than 15%, preferably less than 10%, when a sample recording layer, on which recording marks have been created by irradiation with a blue laser beam having a wavelength of 405 nm, is maintained under conditions of a temperature of 80° C. and relative humidity of 85% for 96 hours”. The change in reflectivity due to deterioration of the recording layer is more marked upon irradiation with a blue laser beam, because the blue laser beam has a shorter wavelength than that of a red laser beam. Accordingly, the durability of optical discs on which recording and reading of information has been performed using a blue laser beam is expected to be decreased compared with the case where a red laser beam is used. In other words, a recording layer to be applied to optical discs using blue laser should have higher durability than known equivalents. For this reason, the criterion of durability is set herein as a condition that the reflectivity of an optical disc without provided with a protective layer hardly decreases even when the optical disc has been exposed to very severe conditions of high temperature and high humidity, i.e., a temperature of 80° C. and relative humidity of 85%, for a long term of 96 hours. In this connection, the durability of optical discs was examined in above-mentioned Patent Documents 1 and 7, but the durability was merely examined under conditions milder than the conditions specified herein. In Patent Document 7, a durability test was carried out by maintaining a sample at a temperature of 60° C. and relative humidity of 90% for 120 hours. Specifically, it is carried out at a temperature lower than that in the present invention. In Patent Document 1, a durability test was carried out by maintaining a sample at a temperature of 80° C. and relative humidity of 85% for 50 hours. Specifically, it is carried out for a time period shorter than that in the present invention. In both of these, no durability test under high temperature conditions for a long term as in the present invention is carried out.

Next, experimental samples of recording layers of tin-based alloys including tin and various alloy components were prepared; the creativity of recording marks was determined upon irradiation with a blue laser beam having a wavelength of 405 nm; and changes in reflectivity (durability) of recording layers when exposed to high temperature and high humidity conditions were determined.

As a result, the present inventors have found that the criterion of durability specified herein can be satisfied while maintaining excellent recording properties such as creativity of recording marks and reflectivity, by using tin-based alloys containing a specific amount of at least one of neodymium (Nd), gadolinium (Gd), and lanthanum (La), as described later in detail in Experimental Examples.

The recording layer according to the first embodiment of the present invention will be illustrated in detail below.

The recording layer according to the first embodiment of the present invention includes a tin-based alloy containing a total of 1.0 to 15 atomic percent of at least one selected from the group consisting of neodymium (Nd), gadolinium (Gd), and lanthanum (La). As shown in after-mentioned Experimental Examples, tin is excellent in recording properties such as creativity of recording marks, but it is inferior in durability under high temperature conditions. The durability can be significantly improved while maintaining excellent recording properties by compounding a specific amount of at least one element selected from the group consisting of neodymium (Nd), gadolinium (Gd), and lanthanum (La) Although details remain unknown, it is conceivable that the oxidation of tin is suppressed by controlling these elements that are more susceptible to oxidation than tin, and this improves the durability.

Each of neodymium (Nd), gadolinium (Gd), and lanthanum (La) can be used alone or in combination.

The total amount of these elements should be 1.0 atomic percent or more and 15 atomic percent or less, as demonstrated by data in after-mentioned Experimental Examples. If the total amount is less than 1.0 atomic percent, the desired durability may not be obtained. However, if these elements are added in excess, the initial reflectivity may decrease, and the upper limit of the total amount of the elements may be set at 15 atomic percent. The total content of the elements is preferably 3 atomic percent or more and 12 atomic percent or less, and more preferably 5 atomic percent or more and 10 atomic percent or less.

The recording layer according to the first embodiment of the present invention includes the above components with the remainder being tin, and it may further contain other components within the range not adversely affecting the operation of the present invention. For example, the recording layer may contain gaseous components such as O₂ and N₂ inevitably introduced during the deposition of the recording layer by sputtering. Alternatively or in addition, it may contain impurities inherently contained in a tin-based alloy used as a material to be melted.

The thickness of the recording layer is preferably in the range from 10 nm to 50 nm. As shown in Experimental Examples mentioned later, the recording layer having a thickness of 10 nm or more has an increased initial reflectivity. In contrast, the thickness is preferably 50 nm or less in consideration of the creativity of recording marks, although the upper limit of the thickness is not limited in view of initial reflectivity. The thickness of the recording layer is more preferably 15 nm or more and 40 nm or less, and further preferably 20 nm or more and 35 nm or less.

The optical information storage medium according to the first embodiment of the present invention includes the recording layer composed of tin-based alloy according to the first embodiment of the present invention. The configuration other than the recording layer is not specifically limited, and any configuration or structure known in the field of optical information storage media can be employed.

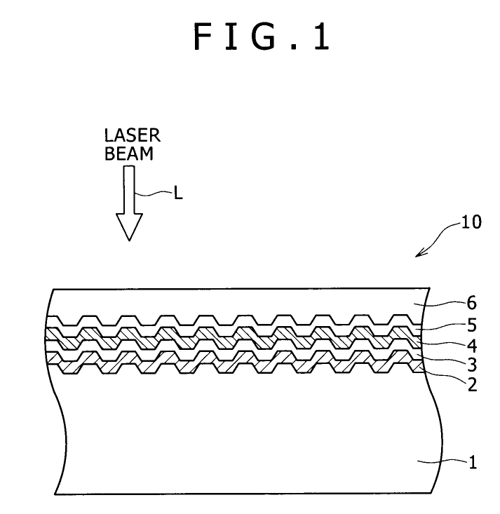

FIG. 1 schematically illustrates the configuration of a preferred embodiment of the optical information storage media (optical discs) according to the present invention. FIG. 1 depicts a write-once optical disc 10 on which data recording and reading can be carried out by applying a blue laser beam having a wavelength of about 380 nm to about 450 nm, preferably a wavelength of about 405 nm, to a recording layer. The optical disc 10 includes a substrate 1, an optical control layer 2, dielectric layers 3 and 5, a recording layer 4 arranged between the dielectric layers 3 and 5, and a light transmission layer 6. The dielectric layers 3 and 5 are provided to protect the recording layer 4, thereby allowing long-term storage of recorded information.

The optical disc according to this embodiment has a feature of using a tin-based alloy satisfying the above-specified requirements as a material for the recording layer 4. Materials for the substrate 1 and other layers (the optical control layer 2 and the dielectric layers 3 and 5) other than the recording layer 4 are not specifically limited and are appropriately selected from among common materials. The reflectivity can be increased by using, for example, a silver alloy (Ag alloy) as the material for the optical control layer 2. It should be noted that the dielectric layers 3 and 5 can be omitted by using the recording layer according to the first embodiment of the present invention.

The thin film of tin-based alloy is preferably deposited by sputtering. The solubility limit of the alloy elements (neodymium (Nd), gadolinium (Gd), and lanthanum (La)) used herein with respect to tin is 10 atomic percent or less in equilibrium. However, the alloy elements (neodymium (Nd), gadolinium (Gd), and lanthanum (La)) in the thin film deposited by sputtering can be forcedly dissolved in the tin matrix as a result of vapor quenching peculiar to sputtering. Accordingly, the alloy elements are more uniformly distributed in the tin matrix, resulting in a remarkable enhancement typically in durability, as compared to the case where a thin film of tin-based alloy is deposited by another deposition process than sputtering.

A target for use in sputtering is preferably composed of a tin-based alloy prepared typically by melting and casting (hereinafter also referred to as “ingot tin-based alloy target”) This is because such an ingot tin-based alloy target has a uniform crystal structure, shows a stable sputtering rate, and emits atoms at uniform angles. Thus, the target contributes to the deposition of a recording layer having a homogenous alloy composition and a homogeneous thickness, and this in turn contributes to the production of an optical disc having higher performance. In addition, the oxygen content in the ingot tin-based alloy target material is preferably controlled to 100 ppm or less. Thus, the thin film of tin-based alloy has further improved reflectivity and durability, because it becomes easy to keep the rate of film deposition constant, and the oxygen content in the thin film of tin-based alloy becomes low.

Recording Layer For Optical Information Storage Media According to Second Embodiment of the Present Invention

The recording layer for optical information storage media according to the second embodiment of the present invention is a recording layer to create recording marks upon irradiation with a laser beam. This recording layer includes a tin-based alloy containing 1 atomic percent to 30 atomic percent of boron (B). The recording layer may further contain 50 atomic percent or less (exclusive of 0 atomic percent) of indium (In) and/or may further contain a total of 15 atomic percent or less (exclusive of 0 atomic percent) of at least one selected from the group consisting of yttrium (Y), lanthanum (La), neodymium (Nd), and gadolinium (Gd).

The present inventors made intensive investigations focusing on tin-based alloys, in order to provide a recording layer on which information can be recorded by a hole creating recording system, and which has a high C/N ratio (i.e., has a low noise). As a result, they have found that the objects can be achieved by using a tin-based alloy containing tin and a specific amount of boron (B) (hereinafter also referred to as “Sn—B alloy”). An embodiment of the present invention has been made based on these findings. The present inventors have also found that a recording layer having higher durability (less reduction in reflectivity) under high temperature and high humidity conditions is obtained by using a tin-based alloy (hereinafter also referred to as “Sn—B-Z alloy”) based on a Sn—B alloy and further containing a specific amount of at least one element selected from the group consisting of yttrium (Y), lanthanum (La), neodymium (Nd), and gadolinium (Gd) (hereinafter also referred to as “element(s) belonging to Group Z”).

Initially, how the present inventors have achieved this embodiment will be explained.

The reason why the present inventors focused on tin-based alloys herein is as follows. Tin (Sn) is inferior in reflectivity to aluminum (Al), silver (Ag), and copper (Cu), but it is superior in creativity of recording marks upon irradiation with a laser beam. This is probably because the melting point of tin is about 232° C. and is significantly lower than those of aluminum (about 660° C.), silver (about 962° C.), and copper (about 1085° C.); and, when used as a recording layer, a thin film of tin-based alloy containing tin and one or more alloy elements readily melts upon irradiation with a laser beam to thereby provide excellent recording properties. In addition, when used in a recording layer mainly aiming to be applied to next-generation optical discs using blue-violet laser as in the present invention, aluminum (Al), for example, may fail to create recording marks easily. Thus, tin-based alloys are selected in the present invention.

The hole creating recording system, however, has a problem of low C/N ratio as described above. The C/N ratio is the ratio of a signal of a recording mark region (carrier, C) to a noise of an unrecorded region (noise, N) and is determined by applying light to the recording layer and measuring a change in reflectivity. With an increasing C/N ratio, an apparent noise level decreases and a response speed becomes higher. Optical discs, for example, should generally have a C/N ratio of about 40 dB or more. Tin for use herein, if used alone, may not have a sufficiently high C/N ratio, even though it has a low melting point and a relatively high reflectivity.

To increase the C/N ratio of tin-based alloys, above-mentioned Patent Document 5, for example, proposes a technique of adding an element having a predetermined surface tension (Zn, Ga, Ge, Y, Sm, Eu, Tb, or Dy) to a tin-based alloy containing elements such as Bi, Sb, and Pb. This technique is on the basis of a specified relationship between the surface tension and recording properties (signal properties). Specifically, in a hole creating recording system, once a hole is created in a portion of a region irradiated with a laser beam, the hole tends to expand rapidly due to surface tension. If a recording material has an excessively high surface tension, the recording material forms a small spherical mass and remains inside or around the hole. In contrast, if the recording material has an excessively low surface tension, the recording material remains as an irregular residue inside the hole. Consequently, the C/N ratio is decreased in any case. Patent Document 5 mentions that the C/N ratio is improved by adding the above-mentioned element, because the surface tension of the recording layer can be controlled within an adequate range.

In contrast, the present inventors made intensive investigations on elements that can be added to tin, based on the viewpoint that the surface roughness (Ra) of a recording layer is minimized and the noise (N) of an unrecorded region is thereby reduced in order to increase the C/N ratio. In general, the reflectivity is known to vary depending on morphology of a recording layer. A recording layer having a rough surface has a low reflectivity and a large noise in an unrecorded region, because such a rough surface is likely to cause scattering of light. In contrast, a recording layer having a smooth surface and showing a small average grain diameter has a high reflectivity and an increased C/N ratio and shows an improved response speed.

It is effective to add an element having an extremely different atomic radius from that of tin into a tin alloy in order to reduce the surface roughness of the recording layer. This relaxes the strain, reduces the grain size, and reduces the roughness of surface. The present inventors made investigations to discover elements that satisfy the above requirements and without adversely affecting the excellent recording properties (initial reflectivity and creativity of recording marks) owing to tin. As a result, they have found that the purpose is achieved by adding a specific amount of boron to tin.

Boron has an atomic radius of 1 angstrom or less, much smaller than that (1.6 angstrom) of tin. When boron and tin having considerably different atomic radii are mixed, strain heat is generated, the particle diameter decreases in order to relax the strain, and the surface roughness decreases, as mentioned above.

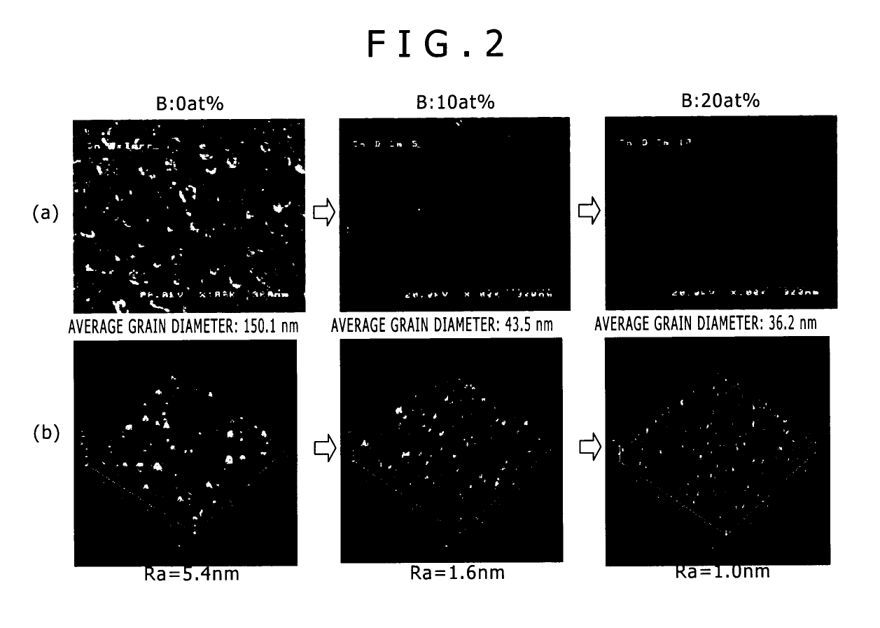

FIG. 2 depicts surface shapes of Sn—B alloy thin films having different boron contents of samples prepared in after-mentioned Experimental Examples. FIG. 2(a) depicts scanning electron microscope (SEM) images of the Sn—B alloy thin films, with measured average grain diameters thereof. FIG. 2(b) depicts atomic force microscope (AFM) images of the Sn—B alloy thin films with measured surface roughness (Ra) thereof. FIGS. 2(a) and 2(b) depict images of a sample having a boron content of 0 atomic percent (Sample 1 in after-mentioned Table 2), one having a boron content of 10 atomic percent (Sample 5 in Table 2), and one having a boron content of 20 atomic percent (Sample 6 in Table 2) in this order from the left.

FIG. 2 demonstrates that, when 10 atomic percent to 20 atomic percent of boron is added to tin (average grain diameter: 150.1 nm, surface roughness Ra: 5.4 nm), the average grain diameter decreases to the range from about 36 nm to 44 nm and the surface roughness Ra also decreases to the range from 1.0 nm to 1.6 nm. These samples each have low noise and a high C/N ratio as shown in Table 2 below. The average grain diameter herein is determined by taking a scanning electron microscope image of a sample with the Scanning Electron Microscope (SEM) S-4000 (Hitachi, Ltd.), plotting a line of 1 μm long on the scanning electron microscope image as calculated based on a reduction scale, counting the number of crystal grains on the line, and dividing the length of the line by the number of grains. The surface roughness Ra is measured with the SPI 4000 Probe Station (Seiko Instruments Inc.) in atomic force microscope (AFM) mode.

The present inventors made further investigations on elements to improve the durability under high temperature and high humidity conditions (elements that can improve durability of Sn—B alloys), in addition to improvements in C/N ratio. More specifically, experimental samples of recording layers were prepared from Sn—B based alloys containing different alloy components; creativity of recording marks of the recording layers were determined upon irradiation with a blue laser beam having a wavelength of 405 nm; and changes in reflectivity (durability) of the recording layers when exposed to high temperature and high humidity conditions were determined.

Consequently, they have found that, when a Sn—B alloy containing a specific amount of indium or a Sn—B-Z alloy containing a specific amount of at least one element belonging to Group Z, i.e., at least one of yttrium (Y), lanthanum (La), neodymium (Nd), and gadolinium (Gd), is used, the resulting recording layer can satisfy the criterion of durability as specified herein while maintaining excellent recording properties and high C/N ratio, as demonstrated in detail in after-mentioned Experimental Examples.

The criterion of durability employed herein is defined as a condition that “the change in reflectivity is less than 15%, preferably less than 10%, when a sample recording layer, on which recording marks have been created by irradiation with a blue-violet laser beam having a wavelength of 405 nm, is maintained under conditions of a temperature of 80° C. and relative humidity of 85% for 96 hours”. The change in reflectivity due to deterioration of the recording layer (recording film) is more marked upon irradiation with a blue-violet laser beam, because the blue-violet laser beam has a shorter wavelength than that of a red laser beam. Accordingly, the durability of optical discs on which recording and readout of information has been performed using a blue-violet laser beam is expected to be decreased compared with the case where a red laser beam is used. In other words, a recording layer to be applied to optical discs using blue-violet laser should have higher durability than known equivalents. For this reason, the criterion of durability is set herein as a condition that the reflectivity of an optical disc without provided with a protective layer hardly decreases even when the optical disc has been exposed to very severe conditions of high temperature and high humidity, i.e., a temperature of 80° C. and relative humidity of 85%, for a long term of 96 hours. In this connection, the durability of optical discs was examined in above-mentioned Patent Documents 1 and 7, but the durability was merely examined under conditions milder than the conditions specified herein. In Patent Document 7, a durability test was carried out by maintaining a sample at a temperature of 60° C. and relative humidity of 90% for 120 hours. Specifically, it is carried out at a temperature lower than that in the present invention. In Patent Document 1, a durability test was carried out by maintaining a sample at a temperature of 80° C. and relative humidity of 85% for 50 hours. Specifically, it is carried out for a time period shorter than that in the present invention. In both of these, no durability test under high temperature and high humidity conditions for a long term as in the present invention is carried out.

The recording layer according to the second embodiment of the present invention will be illustrated in detail below.

The recording layer according to the second embodiment of the present invention contains boron in the range of 1 atomic percent or more and 30 atomic percent or less. Tin (Sn) has a low C/N ratio and is poor in durability under high temperature and high humidity conditions, although it excels in recording properties such as initial reflectivity and creativity of recording marks. In contrast, a tin-based alloy further containing a specific amount of boron acts to reduce the surface roughness Ra and thereby reduce noise; which results in a higher C/N ratio, as demonstrated in Experimental Examples below.

The boron content should be 1 atomic percent or more and 30 atomic percent or less. When the total boron content is less than 1 atomic percent, the noise may not be effectively desirably reduced. In contrast, if boron is excessively contained, the initial reflectivity may be lowered as demonstrated in Experimental Examples below, and the upper limit of the total boron content should be 30 atomic percent. The boron content is preferably 5 atomic percent or more and 25 atomic percent or less, and more preferably 10 atomic percent or more and 20 atomic percent or less.

As is described above, Sn—B alloys for use herein excel in recording properties and have high C/N ratios. They are, however, slightly inferior in durability under high temperature and high humidity conditions as demonstrated in after-mentioned Experimental Examples.

For improving the durability in the Sn—B alloys, it is preferred (a) to add indium in the range of 50 atomic percent or less (exclusive of 0 atomic percent) and/or (b) to add at least one of elements belonging to Group Z, i.e., at least one of yttrium (Y), lanthanum (La), neodymium (Nd), and gadolinium (Gd), in a total of 15 atomic percent or less (exclusive of 0 atomic percent), as mentioned below. This significantly increases the durability of Sn—B alloys while maintaining their excellent recording properties and high C/N ratios.

The indium content is preferably 50 atomic percent or less (exclusive of 0 atomic percent), on the basis of data in after-mentioned Experimental Examples. The upper limit of the indium content should be 50 atomic percent, because indium in excess may reduce the initial reflectivity. The indium content is desirably 5 atomic percent or more in order to effectively improve the durability. The indium content is preferably 10 atomic percent or more and 40 atomic percent or less, and more preferably 20 atomic percent or more and 30 atomic percent or less.

The total content of elements belonging to Group Z, i.e. yttrium (Y), lanthanum (La), neodymium (Nd), and gadolinium (Gd) is preferably 15 atomic percent or less (exclusive of 0 atomic percent), on the basis of data in after-mentioned Experimental Examples. The upper limit of the total content of these elements should be 15 atomic percent, because the elements in excess may reduce the initial reflectivity. The total content of the elements belonging to Group Z is desirably 1.0 atomic percent or more in order to effectively improve the durability. The total content of these elements is preferably 2 atomic percent or more and 13 atomic percent or less, and more preferably 5 atomic percent or more and 10 atomic percent or less.

Each of the elements belonging to Group Z can be contained in Sn—B alloys alone or in combination.

The Sn—B alloys may contain both indium and at least one of the elements belonging to Group Z in order to further improve the durability.

Although details remain unknown, the durability is increased by the addition of indium and/or the element(s) belonging to Group Z, probably because these elements are more susceptible to oxidation than tin, and the addition of these elements suppresses the oxidation of tin to thereby improve the durability.

The lower limits of the contents of these elements are not particularly limited, merely from the viewpoint of “achieving excellent recording properties and high C/N ratios” as an object of the present invention. This is because even a Sn—B—Y alloy where Y is an element belonging to Group Z (Sample 9 in Table 2) or a Sn—B—In alloy (Sample 18 in Table 2) each of which has a content of the element lower than the lower limit achieves excellent recording properties and a high C/N ratio equivalent to those of Sn—B alloys (Samples 2 to 7 in Table 2) which satisfy the requirements herein, as demonstrated in after-mentioned Experimental Examples.

The recording layer according to the second embodiment of the present invention includes a tin-based alloy containing the components with the remainder being tin. The tin content is preferably 40 atomic percent, more preferably 50 atomic percent or more, and further preferably 60 atomic percent or more. The tin-based alloy for use herein may further contain one or more other components within the range not adversely affecting the operation of the present invention. For example, it may contain gaseous components such as O₂ and N₂ inevitably introduced during the deposition of the recording layer by sputtering. Alternatively or in addition, it may contain impurities inherently contained in a tin-based alloy used as a material to be melted.

The thickness of the recording layer is preferably in the range from 10 nm to 50 nm. A recording layer having a thickness of 10 nm or more has an increased initial reflectivity. In contrast, the thickness is preferably 50 nm or less in consideration of the creativity of recording marks, although the upper limit of the thickness is not limited in view of the initial reflectivity. The thickness of the recording layer is more preferably 15 nm or more and 40 nm or less, and further preferably 20 nm or more and 35 nm or less.

The optical information storage medium according to the second embodiment of the present invention includes the recording layer composed of tin-based alloy according to the second embodiment of the present invention. The configuration other than the recording layer is not specifically limited, and any configuration or structure known in the field of optical information storage media can be used.

FIG. 2 schematically illustrates the configuration of a preferred embodiment of the optical information storage media (optical discs) according to the second embodiment of the present invention. FIG. 2 depicts a write-once optical disc 10 on which data recording and reading can be carried out by applying a blue-violet laser beam having a wavelength of about 380 nm to about 450 nm, preferably a wavelength of about 405 nm, to a recording layer. The optical disc 10 includes a substrate 1, an optical control layer 2, dielectric layers 3 and 5, a recording layer 4 arranged between the dielectric layers 3 and 5, and a light transmission layer 6. The dielectric layers 3 and 5 are provided to protect the recording layer 4, thereby allowing long-term storage of recorded information.

The optical disc according to this embodiment has a feature of using a tin-based alloy satisfying the above-specified requirements as a material for the recording layer 4. Materials for the substrate 1 and layers (the optical control layer 2 and the dielectric layers 3 and 5) other than the recording layer 4 are not specifically limited and are appropriately selected from among common materials. The reflectivity can be increased by using, for example, a silver alloy (Ag alloy) as the material for the optical control layer 2. It should be noted that the dielectric layers 3 and 5 can be omitted by using the recording layer according to the second embodiment of the present invention.

A thin film of the tin-based alloy can be deposited according to a common process for the deposition of thin films, but is preferably deposited by sputtering. A composited sputtering target, for example, can be prepared according to the process described in after-mentioned Experimental Examples.

A sputtering target of tin-based alloy containing the above-mentioned elements is preferably used as a target in sputtering.

Recording Layer for Optical Information Storage Media According to Third Embodiment of the Present Invention

The recording layer for optical information storage media according to the third embodiment of the present invention is a recording layer to create recording marks upon irradiation with a laser beam. The recording layer includes a tin-based alloy containing a total of 1 to 50 atomic percent of nickel (Ni) and/or cobalt (Co). The recording layer may further contain, as additional element(s), a total of 30 atomic percent or less (exclusive of 0 atomic percent) of at least one selected from the group consisting of indium (In), bismuth (Bi), and zinc (Zn).

The reasons why the present inventors selected tin as a base metal are as follows. When used in an optical recording layer, tin (Sn) is inferior in reflectivity to aluminum (Al), silver (Ag), and copper (Cu), but it is much superior in creativity of recording marks upon irradiation with a laser beam. This is probably because the melting point of tin is about 232° C. and is significantly lower than those of aluminum (about 660° C.), silver (about 962° C.), and copper (about 1085° C.); a thin film of tin-based alloy readily melts or deforms even at low temperatures upon irradiation with a laser beam; and the optical information storage media using the recording layer show excellent recording properties upon irradiation with a laser beam even at a low power. In addition, when used in a recording layer mainly aiming to be applied to next-generation optical discs using blue-violet laser as in the present invention, an aluminum (Al) based alloy, for example, may fail to create recording marks easily. Thus, tin-based alloys are selected in the present invention.

Next, in the tin-based alloys, nickel (Ni) and cobalt (Co) are equivalent or compatible elements in that they act to increase the C/N ratio, reflectivity, and corrosion resistance, to reduce the jitter, and to reduce the surface roughness of the optical recording layer, thus creating recording marks with suitable dimensions. The total content of nickel and cobalt should be 1 atomic percent or more for effectively exhibiting these activities. However, if the total content of nickel and cobalt exceeds 50 atomic percent, the tin content may be relatively insufficient and it may be difficult to exhibit the inherent characteristic properties of tin effectively. In view of these advantages and disadvantages, the total content of nickel and cobalt is more preferably 5 atomic percent or more and 35 atomic percent or less, and further preferably 15 atomic percent or more and 25 atomic percent or less.

Indium (In), bismuth (Bi), and zinc (Zn) elements which may be further contained in the tin-based alloy are more susceptible to oxidation than tin and sacrifice themselves to prevent deterioration caused by oxidation of tin. The advantages of these three elements may be exhibited even in trace amounts, but the total content of them is desirably 3 atomic percent or more, and more desirably 5 atomic percent or more so as to exhibit the advantages practically reliably. However, when these elements are contained in excess, the tin content may be relatively insufficient, and it may be difficult to exhibit the inherent characteristic properties of tin. The total content of these elements is therefore preferably controlled to 30 atomic percent or less, and more preferably to 25 atomic percent or less.

The rare-earth elements which may be further contained in the tin-based alloy not only contribute to improvements in corrosion resistance and surface smoothness of the recording layer but also reduce the jitter. For exhibiting these advantages effectively, the total content of these elements is preferably 0.5 atomic percent or more, and more preferably 1.0 atomic percent or more. However, these elements, if contained in excess, may elevate the melting point of the optical recording layer and it may be difficult to create recording marks by irradiation with a laser beam. The total content is therefore desirably controlled to 10 atomic percent or less, and more preferably to 8 atomic percent or less. The rare-earth elements include, for example, yttrium and lanthanum series elements such as neodymium (Nd) and lanthanum (La). Each of these elements can be used alone or in any optional combination. Among them, yttrium (Y) is particularly preferred.

An optical recording layer of the tin-based alloy preferably has a thickness in the range of 1 to 50 nm so as to yield a recording layer capable of reliably recording data with a stable precision, while such preferred thickness may vary depending on the structure of the optical information storage medium. An optical recording layer having an excessively small thickness of less than 1 nm may be susceptible to defects such as pores on its surface and thereby fail to provide a satisfactory recording sensitivity, even if at least one of an optical control layer and a dielectric layer is arranged as an upper layer and/or an underlayer of the optical recording layer. In contrast, an optical recording layer having an excessively large thickness exceeding 50 nm may fail to create satisfactory recording marks, because heat generated by the application of laser beams may excessively rapidly diffuse in such a thick recording layer. From the viewpoint of reflectivity as an optical disc, the thickness of the recording layer is more preferably 8 nm or more and 30 nm or less, and further preferably 12 nm or more and 20 nm or less when neither dielectric layer nor optical control layer is arranged. The thickness is more preferably 3 nm or more and 30 nm or less, and further preferably 5 nm or more and 20 nm or less when at least one of a dielectric layer and an optical control layer is arranged.

A laser beam to be applied for the recording of information preferably has a wavelength of 350 to 700 nm. A laser beam having an excessively short wavelength less than 350 nm may be significantly absorbed typically by a covering layer (light transmission layer) and may not sufficiently contribute to the writing and reading of information on an optical recording layer. In contrast, a laser beam having an excessively long wavelength exceeding 700 nm may have insufficient energy and may not sufficiently contribute to the creation of recording marks on an optical recording layer. From these viewpoints, a laser beam for use in information recording may have a wavelength of more preferably 350 nm or more and 660 nm or less, and further preferably 380 nm or more and 650 nm or less.

A sputtering target for the deposition of the recording layer (sputtering target according to the third embodiment) may have a composition basically the same as a desired alloy composition of the recording layer. In other words, the recording layer having a desired alloy composition can be easily deposited by sputtering using a sputtering target having a composition as with the alloy composition of the recording layer.

Characteristic properties of the tin-based alloys for use in the present invention will be illustrated in contrast with the known techniques.

As is described above, when used in an optical recording layer, the tin-based alloys for use in the present invention are slightly inferior in reflectivity to aluminum (Al), silver (Ag) and copper (Cu) disclosed in Patent Documents 1 to 4. The tin-based alloys, however, further more satisfactorily contribute to the creation of recording marks upon irradiation with a laser beam than these metals. This is probably because tin has a much lower melting point than those of aluminum (Al), silver (Ag), and copper (Cu), and a thin film of tin-based alloy readily melts or deforms upon irradiation with a laser beam to exhibit excellent recording properties, as described above.

In particular, when an aluminum (Al) thin film, for example, is used in a recording layer mainly aiming to be applied to next-generation optical discs using a blue-violet laser beam as irradiation light as in the present invention, it may be difficult to create recording marks upon irradiation with a laser beam at a low power. The technique according to the present invention, however, will eliminate this possibility.

After investigations, the present inventors found that the tin-based alloys disclosed in Patent Documents 5 to 7 had the following disadvantages.

Patent Document 6 discloses an optical recording layer including an alloy of 40 percent by mass of tin (Sn), 55 percent by mass of indium (In), and 5 percent by mass of copper (Cu) and having a film thickness of 2 to 4 nm. This alloy contains, in terms of atomic percent, 53.5 atomic percent of indium, 37.7 atomic percent of tin, and 8.8 atomic percent of copper. It is difficult, however, to yield a practically sufficient C/N ratio using this optical recording layer. The alloy layer disclosed in this patent document has a thickness of 2 to 4 nm. This thickness, however, is too small for the alloy composition to yield a practically sufficient reflectivity.

Patent Document 7 discloses a recording layer containing a Sn—Bi alloy in combination with a material more susceptible to oxidation than tin and bismuth. This alloy, however, fails to provide a C/N ratio and a recording sensitivity higher than those in tin-based alloy recording layer according to the present invention.

Patent Document 5 discloses an optical recording layer including a tin-based alloy. This tin-based alloy contains 84 atomic percent of tin (Sn), 10 atomic percent of zinc (Zn), and 6 atomic percent of antimony (Sb). Even this tin-based alloy, however, fails to provide a C/N ratio, a recording sensitivity, and a reflectivity higher than those in tin-based alloy recording layers according to the present invention.

These also demonstrate that optical recording layers according to the present invention are more useful than known equivalents.

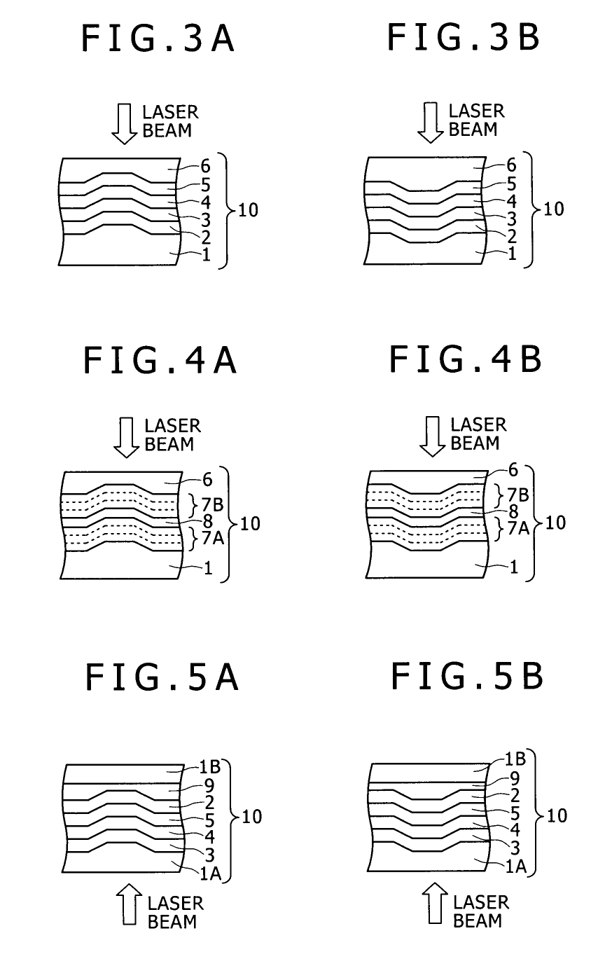

FIGS. 3 to 6 depict schematic cross-sectional views showing write-once optical information storage media (optical discs) according to embodiments of the present invention by way of example. These storage media a reconfigured to write and read data by applying a laser beam with a wavelength of 350 to 700 nm to a recording layer. The optical discs shown in FIGS. 3 (A), 4(A), 5 (A), 6 (A), and 6(C) each have a convex recording site, and those shown in FIGS. 3 (B), 4(B), 5 (B), 6 (B), and 6(D) each have a concave groove recording site.

Each of optical discs 10 in FIG. 3 includes a substrate 1, an optical control layer 2, dielectric layers 3 and 5, a recording layer 4 arranged between the dielectric layer 3 and 5, and a light transmission layer 6. The dielectric layers 3 and 5 are provided to protect the recording layer 4, thereby allowing long-term storage of recorded information.

Each of optical discs 10 in FIG. 4 includes a substrate 1, a zeroth recording layer group (a group of layers including an optical control layer, a dielectric layer, and a recording layer) 7A, an intermediate layer 8, a first recording layer group (a group of layers including an optical control layer, a dielectric layer, and a recording layer) 7B, and a light transmission layer 6. FIG. 3 illustrates optical discs of a single-layer DVD-R, a single-layer DVD+R, or a single-layer HD DVD-R type. FIG. 4 illustrates optical discs of a double-layer DVD-R, a double-layer DVD+R, or a double-layer HD DVD-R type. These figures also show an intermediate layer 8 and an adhesive layer 9.

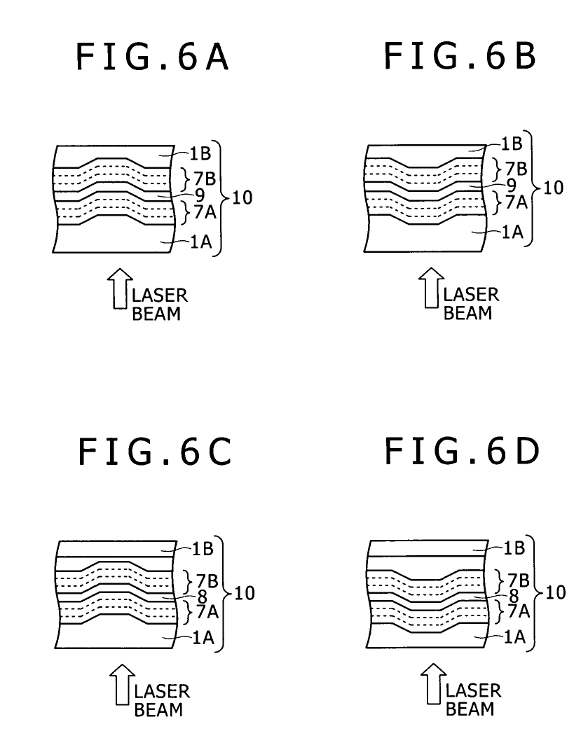

A group of layers constituting the zeroth and first recording layer groups 7A and 7B in FIGS. 4 and 6 may have a three-layer structure, a two-layer structure, or a single-layer structure including a recording layer alone. The three-layer structure may be a structure of, for example, (dielectric layer)/(recording layer)/(dielectric layer), (dielectric layer)/(recording layer)/(optical control layer), or (recording layer)/(dielectric layer)/(optical control layer) arranged in this order from above in the figures. The two-layer structure may be a structure of, for example, (recording layer)/(dielectric layer), (dielectric layer)/(recording layer), (recording layer)/(optical control layer), or (optical control layer)/(recording layer) arranged in this order from above in the figures.

The criterion of durability employed herein is defined as a condition that “the change in reflectivity upon irradiation with a blue laser beam having a wavelength of 405 nm is less than 15%, preferably less than 10%, after a sample including a substrate 1 and a recording layer 4 alone arranged thereon has been maintained under conditions of a temperature of 80° C. and relative humidity of 85% for 96 hours”. The change in reflectivity due to deterioration of the recording layer (recording film) is more marked upon irradiation with a blue laser beam, because the blue laser beam has a shorter wavelength than that of a red laser beam. Accordingly, the durability of optical discs on which recording and reading of information has been performed using a blue laser beam is expected to be decreased compared with the case where a red laser beam is used. A recording layer to be applied to optical discs using blue-violet laser should therefore have higher durability than known equivalents.

In this connection, the durability of optical discs was also examined in above-mentioned Patent Documents 1 and 7, but the durability was merely examined under conditions milder than the conditions specified herein. In Patent Document 6, a durability test was carried out by maintaining a sample at a temperature of 60° C. and relative humidity of 90% for 120 hours. Specifically, it is carried out at a temperature lower than that in the present invention. In Patent Document 1, a durability test was carried out by maintaining a sample at a temperature of 80° C. and relative humidity of 85% for 50 hours. Specifically, it is carried out for a time period shorter than that in the present invention. In both of these, no durability test under high temperature and high humidity conditions for a long term as in the present invention is carried out.

An optical disc as a representative embodiment of the present invention has a feature in that it uses a tin-based alloy satisfying the above requirements as a material for a recording layer 4 as shown in FIGS. 3 to 6. Materials for the substrate 1, the optical control layer 2, the dielectric layers 3 and 5, and other components than the recording layer 4 are not particularly limited and can be selected as appropriate from among common or known materials.

Specifically, materials for the substrate include polycarbonate resins, norbornene resins, cyclic olefin copolymers, and amorphous polyolefins. Materials for the optical control layer include metals such as Ag, Au, Cu, Al, Ni, Cr, and Ti, and alloys of these metals. Materials for the dielectric layers include ZnS—SiO₂; oxides typically of Si, Al, Ti, Ta, Zr, and Cr; nitrides typically of Ge, Cr, Si, Al, Nb, Mo, Ti, and Zn; carbides typically of Ge, Cr, Si, Al, Ti, Zr, and Ta; fluorides typically of Si, Al, Mg, Ca, and La; and mixtures of these.

When at least one of an optical control layer and a dielectric layer is arranged to thereby increase the reflectivity as an optical disc as mentioned above, the thickness of the recording layer is preferably 1 to 50 nm, more preferably 3 to 30 nm, and further preferably 5 to 20 nm.

As an optical recording layer having the configuration as specified herein is used, a part or all of the optical control layer 2 and the dielectric layers 3 and 5 can be omitted. The thickness of the optical recording layer, if used as a single layer, is preferably 8 to 50 nm, and more preferably 10 to 30 nm.

The optical recording layer of tin-based alloy is preferably deposited by sputtering. Specifically, the alloy elements (Ni, Co, In, Bi, Zn, and rare-earth elements) used herein in addition to tin have specific solubility limits with respect to tin in thermal equilibrium. However, the alloy elements in a thin film deposited by sputtering are more uniformly distributed in tin matrix, and the resulting thin film has homogenous properties and is likely to have more stable optical properties and higher environmental resistance.

A target for use in sputtering is preferably composed of a tin-based alloy prepared by melting and casting (hereinafter also referred to as “ingot tin-based alloy target”). This is because such an ingot tin-based alloy target has a uniform crystal structure, shows a stable sputtering rate, and emits atoms at uniform angles. Thus, the target contributes to the deposition of a recording layer having a homogenous alloy composition, and this in turn contributes to the production of an optical disc being homogenous and having high performance.

During the preparation of a target, trace amounts of impurities such as nitrogen, oxygen, and other gaseous components in atmosphere, and components of a melting furnace may contaminate the target. The component compositions of a recording layer and targets for use according to the present invention do not specify these inevitable trace components (impurities). Trace amounts of such inevitable impurities may be contained, as long as they do not adversely affect the advantages and properties obtained according to the present invention.

Optical Information Storage Medium According to Fourth Embodiment of the Present Invention

The optical information storage medium according to the fourth embodiment of the present invention is an optical information storage medium including a substrate and a recording layer (recording layer according to the fourth embodiment) to create recording marks upon irradiation with a laser beam, in which the recording layer includes a tin-based alloy containing 1 atomic percent to 15 atomic percent of at least one rare-earth element, and the storage medium further includes a protective layer adjacent to a side of the recording layer facing the substrate and/or adjacent to the other side of the recording layer opposite to the substrate. The tin-based alloy may further contain, as additional element(s), a total of 50 atomic percent or less (exclusive of 0 atomic percent) of indium (In) and/or bismuth (Bi).

The reasons why the present inventors selected tin as a base metal are as follows.

When used in a recording layer in an optical information storage medium, tin (Sn) is slightly inferior in reflectivity to aluminum (Al), silver (Ag), and copper (Cu), but it is much superior in creativity of recording marks upon irradiation with a laser beam. This is probably because the melting point of tin is about 232° C. and is significantly lower than those of aluminum (about 660° C.), silver (about 962° C.), and copper (about 1085° C.); and a thin film of tin-based alloy readily melts or deforms upon irradiation with a laser beam to thereby show excellent recording properties even at a low laser power. In addition, when used in a recording layer mainly aiming to be applied to next-generation optical discs using blue-violet laser as in the present invention, an aluminum (Al) based alloy, for example, may fail to crate recording marks easily. Thus, tin is selected as a base material in the present invention.

Next, the rare-earth elements not only contribute to improvements in corrosion resistance and surface smoothness of the recording layer but also reduce the jitter. For exhibiting these advantages effectively, the total content of these elements in the tin-based alloy should be 1 atomic percent or more, and is preferably 1.5 atomic percent or more, and further preferably 3 atomic percent or more. However, these elements, if contained in excess, may elevate the melting point of the optical recording layer to thereby adversely affect the characteristic properties of tin. The total content of these elements is therefore desirably controlled to 15 atomic percent or less, and more desirably to 10 atomic percent or less. The rare-earth elements include, for example, yttrium (Y), neodymium (Nd), lanthanum (La), gadolinium (Gd), and dysprosium (Dy). Each of these can be used alone or in any combination. Of the rare-earth elements, neodymium (Nd) and yttrium (Y) are preferred.

Indium (In) and/or bismuth (Bi) elements which may be further contained in the tin-based alloy as additional element(s) are more susceptible to oxidation than tin and sacrifice themselves to prevent deterioration caused by oxidation of tin. The advantages of indium and bismuth may be exhibited even in trace amounts, but the total content of them is desirably 3 atomic percent or more, and more desirably 8 atomic percent or more so as to exhibit the advantages practically reliably. However, when these elements are contained in excess, the tin content may be relatively insufficient, and it may be difficult to exhibit the inherent characteristic properties of tin. The total content of these elements is therefore preferably controlled to 50 atomic percent or less, and more preferably 30 atomic percent or less.

Recording layers formed of tin-based alloys containing a suitable amount of a rare-earth element, or further containing a suitable amount of indium (In) and/or bismuth (Bi) have high reflectivities and show low noise and high C/N ratios, as described above. These recording layers, however, may not always satisfy demands of users to further improve sensitivity and efficiency in optical information recording typically when they are applied to optical information recording at a low laser power.

The present inventors have found, however, that recording of optical information can be carried out with excellent efficiency and sensitivity upon irradiation with a laser beam even at a low power, while ensuring much lower noise and higher C/N ratio as demanded by users, by arranging a protective layer between a substrate and a recording layer including a tin-based alloy having the above-mentioned component composition and/or on a side of the recording layer opposite to the substrate. This is because the protective layer acts to increase the reflectivity.

Specifically, such a protective layer for use in the present invention is an important component so as to further increase the recording efficiency and recording sensitivity of a recording layer formed of a tin-based alloy containing a rare-earth element or containing a rare-earth element in combination with indium (In) and/or bismuth (Bi) and to ensure performance properties that can sufficient satisfy demands of users. When a protective layer is arranged one of both sides of the recording layer (a side facing the substrate and another side opposite to the substrate), the reflectivity mainly of the protective layer can be increased, and this contributes to the improvement in recording precision. These advantages further increase when the protective layer is arranged on both sides of the recording layer.

Materials for constituting the protective layer include ZnS—SiO₂; ZnS; oxides and nitrides typically of Si, Al, Zr, Ti, Ta, and Cr; carbides of Si and Ti; boron nitride (BN); carbon (C); and mixtures of these. Among them, preferred examples are ZnS—SiO₂ and SiC. The thickness of the protective layer is not particularly limited but is desirably 5 nm or more, and more desirably 10 nm or more, in order to allow the recording layer to have a higher reflectivity and to exhibit properties such as high precision in recording of signals effectively. Although there is no specific upper limit of the thickness of the protective layer, an excessively thick protective layer may cause disadvantages such as reduction in productivity of the optical information storage medium. The thickness is therefore preferably controlled to 200 nm or less, and more preferably to 150 nm or less in view of practical utility.

The protective layer can be deposited by any process not particularly limited, but it is preferably deposited, for example, by sputtering.

An optical recording layer including the tin-based alloy preferably has a thickness in the range of 1 to 50 nm so as to yield a recording layer capable of reliably recording data with a stable precision. An optical recording layer having an excessively small thickness of less than 1 nm may be susceptible to defects such as pores on its surface and thereby fail to provide a satisfactory recording property. In contrast, an optical recording layer having an excessively large thickness exceeding 50 nm may fail to form satisfactory recording marks, because heat generated by the irradiation of laser beams may excessively rapidly diffuse in such a thick recording layer. From these viewpoints, the thickness of the recording layer is more preferably 3 nm or more and 45 nm or less, and further preferably 5 nm or more and 40 nm or less.

A laser beam to be applied for optical information recording preferably has a wavelength of 350 to 700 nm. A laser beam having an excessively short wavelength less than 350 nm may be significantly absorbed typically by a substrate and a protective layer of an optical information storage medium (optical disc) and may not sufficiently contribute to the writing and reading of information on a recording layer. In contrast, a laser beam having an excessively long wavelength exceeding 700 nm may have an increased spot size and may not sufficiently contribute to the creation of recording marks on a recording layer. From these viewpoints, a laser beam for use in optical information recording may have a wavelength of more preferably 380 nm or more and 660 nm or less.

A target for use in sputtering for the deposition of the recording layer according to the fourth embodiment may have a composition basically the same as a desired alloy composition of the recording layer. In other words, the recording layer having a desired alloy composition can be deposited by sputtering using a sputtering target having a composition as with the alloy composition of the recording layer.

Characteristic properties of the tin-based alloy for the deposition of the recording layer of the optical information storage medium according to the fourth embodiment will be illustrated in contrast with the known techniques.

When used in a recording layer, tin as abase metal is inferior in reflectivity to aluminum (Al), silver (Ag), and copper (Cu) Tin, however, further more satisfactorily contributes to the creation of recording marks upon irradiation with a laser beam than these metals. This is probably because tin has a much lower melting point than those of aluminum (Al), silver (Ag), and copper (Cu), and a thin film of tin-based alloy readily melts or deforms upon irradiation with a laser beam to exhibit excellent recording properties, as described above.

In particular, when used in a recording layer mainly aiming to be applied to next-generation optical discs using a blue-violet laser beam as irradiation light as in the present invention, an aluminum (Al) thin film, for example, may fail to create recording marks upon irradiation with a laser beam at a low power. The technique according to the present invention, however, will eliminate this possibility.

After investigations, the present inventors found that the tin-based alloys disclosed in Patent Documents 5 to 7 had the following disadvantages.

Patent Document 6 discloses an optical recording layer including an alloy of 40 percent by mass of tin (Sn), 55 percent by mass of indium (In), and 5 percent by mass of copper (Cu) and having a film thickness of 2 to 4 nm. This alloy contains, in terms of atomic percent, 53.5 atomic percent of In, 37.7 atomic percent of Sn and 8.8 atomic percent of Cu. It is difficult, however, to yield a practically sufficient C/N ratio using this optical recording layer. The alloy layer disclosed in this patent document has a thickness of 2 to 4 nm. This thickness, however, is too small for the alloy composition to yield a practically sufficient reflectivity.

Patent Document 7 discloses a recording layer containing a Sn—Bi alloy in combination with a material more susceptible to oxidation than tin and bismuth. This technique, however, is not suitable for practical use in industrial production, because a sophisticated technique for the deposition of a thin film is required to control the content of the material susceptible to oxidation. In contrast, no sophisticated technique is required for the deposition of a recording layer and the preparation of a target according to the present invention. Specifically, simply a tin-based alloy having an adjusted alloy composition will do to achieve the objects easily.

Patent Document 5 discloses a recording layer including a tin-based alloy. This tin-based alloy contains 84 atomic percent of tin (Sn), 10 atomic percent of zinc (Zn), and 6 atomic percent of antimony (Sb). Even this tin-based alloy, however, fails to provide a C/N ratio, a recording sensitivity, and a reflectivity higher than those in tin-based alloy recording layers according to the present invention.

These also demonstrate that optical recording layers according to the present invention are more useful than known equivalents.

FIG. 1 depicts a schematic cross-sectional view showing a write-once optical information storage medium (optical disc) according to an embodiment of the present invention by way of example. FIG. 1 depicts a write-once optical disc 10 on which data recording and reading can be carried out by applying a laser beam with a wavelength of about 350 to 700 nm to a recording layer. The optical disc 10 includes a substrate 1, a reflective layer (optical control layer) 2, protective layers (dielectric layers) 3 and 5, a recording layer 4 arranged between the protective layers 3 and 5, and a light transmission layer 6. The protective layers 3 and 5 are provided to protect the recording layer 4, thereby allowing long-term storage of recorded information (improving durability) as well as increasing reflectivity and C/N ratio.

The criterion of durability employed herein is defined as a condition that “the change in reflectivity is less than 15%, preferably less than 10%, when a sample recording layer, on which recording marks have been created by irradiation with a blue-violet laser beam having a wavelength of 405 nm, is maintained under conditions of a temperature of 80° C. and relative humidity of 85% for 96 hours”. The change in reflectivity due to deterioration of the recording layer (recording film) is more marked upon irradiation with a blue-violet laser beam, because the blue-violet laser beam has a shorter wavelength than that of a red laser beam. Accordingly, the durability of optical discs on which recording and reading of information has been performed using a blue-violet laser beam is expected to be decreased compared with the case where a red laser beam is used. A recording layer to be applied to optical discs using blue-violet laser should therefore have higher durability than known equivalents.

In this connection, the durability of optical discs was also examined in above-mentioned Patent Documents 1 and 6, but the durability was merely examined under conditions milder than the conditions specified herein. In Patent Document 6, a durability test was carried out by maintaining a sample at a temperature of 60° C. and relative humidity of 90% for 120 hours. Specifically, it is carried out at a temperature lower than that in the present invention. In Patent Document 1, a durability test was carried out by maintaining a sample at a temperature of 80° C. and relative humidity of 85% for 50 hours. Specifically, it is carried out for a time period shorter than that in the present invention. In both of these, no durability test under high temperature and high humidity conditions for a long term as in the present invention is carried out.

An optical disc as a representative embodiment of the present invention has features in that it uses a tin-based alloy satisfying the above requirements as a material for a recording layer 4 as shown in FIG. 1 and that a protective layer is arranged between the recording layer 4 and the substrate 1, and/or, adjacent to a side of the recording layer 4 opposite to the substrate 1. Materials for the substrate 1, the reflective layer (optical control layer) and other components than these layers are not particularly limited and can be selected as appropriate from among common materials.

Specifically, materials for the substrate 1 include polycarbonate resins, acrylic resins, and urethane resins. Materials for the reflective layer (optical control layer) 2 include metals such as Ag, Au, Cu, Al, Ni, Cr, and Ti, and alloys of these metals.

The thickness of the recording layer is preferably 1 to 50 nm, more preferably 3 to 45 nm, and particularly preferably 5 to 40 nm. Preferred materials for the reflective layer (optical control layer) include Ag, Au, Cu, Al, Ni, Cr, and Ti, and alloys of these metals. This is because the reflectivity as a whole optical storage medium including the recording layer and the protective layer can be further improved.

It is also acceptable to further arrange a thin layer having a low thermal conductivity between the substrate and the reflective layer or between the substrate and the recording layer so as to control dimensions (shapes) of recording marks.

The recording layer of tin-based alloy is preferably deposited by sputtering. Specifically, the alloy elements, such as rare-earth elements, indium, and bismuth, used herein in addition to tin have specific solubility limits with respect to tin in thermal equilibrium. However, the alloy elements in a thin film deposited by sputtering are more uniformly distributed in tin matrix, and the resulting thin film has homogenous properties and is likely to have more stable optical properties and higher environmental resistance.

A target for use in sputtering is preferably composed of a tin-based alloy prepared by melting and casting (hereinafter also referred to as “ingot tin-based alloy target”). This is because such an ingot tin-based alloy target has a uniform crystal structure, shows a stable sputtering rate, and emits atoms at uniform angles. Thus, the target contributes to the deposition of a recording layer having a homogenous alloy composition, and this in turn contributes to the production of an optical disc being homogenous and having high performance.

During the preparation of a target, trace amounts of impurities such as nitrogen, oxygen, and other gaseous components in atmosphere, and components of a melting furnace may contaminate the target. The component compositions of recording layers and targets for use according to the present invention do not specify these inevitable trace components (impurities). Trace amounts of such inevitable impurities may be contained, as long as they do not adversely affect the advantages and properties obtained according to the present invention.

Recording Layer for Optical Information Storage Media According to Fifth Embodiment of the Present Invention

The recording layer for optical information storage media according to the fifth embodiment of the present invention is a recording layer to create recording marks upon irradiation with a laser beam, in which the recording layer includes a tin-based alloy containing a total of 2 atomic percent to 30 atomic percent of at least one element selected from the group consisting of elements belonging to Groups 4a, 5a, 6a, and 7a of the Periodic Table of Elements, and platinum (Pt), dysprosium (Dy), samarium (Sm), and cerium (Ce). The recording layer may further contain a total of 10 atomic percent or less (exclusive of 0 atomic percent) of neodymium (Nd) and/or yttrium (Y).

The reasons why the present inventors selected tin as a base metal are as follows. When used in an optical recording layer, tin (Sn) is inferior in reflectivity to aluminum (Al), silver (Ag), and copper (Cu), but it is much superior in creativity of recording marks upon irradiation with a laser beam. This is probably because the melting point of tin is about 232° C. and is significantly lower than those of aluminum (about 660° C.), silver (about 962° C.), and copper (about 1085° C.); and a thin film of tin-based alloy readily melts or deforms even at low temperatures upon irradiation with a laser beam to thereby exhibit excellent recording properties upon irradiation with a laser beam even at a low power. In addition, when used in a recording layer mainly aiming to be applied to next-generation optical discs using blue-violet laser as in the present invention, an aluminum (Al) based alloy, for example, may fail to crate recording marks easily. Thus, tin-based alloys are employed in the present invention.

The elements belonging to Groups 4a, 5a, 6a, and 7a of the Periodic Table of Elements, and platinum (Pt), dysprosium (Dy), samarium (Sm), and cerium (Ce) for use in the tin-based alloys are equivalent or compatible elements in that they act to increase the corrosion resistance, to maintain high reflectivity over a long period of time, and to improve the surface smoothness of the optical recording layer. For effectively exhibiting these advantages, the total content of at least one of these elements should be 2 atomic percent or more. However, if these elements are contained in excess amount exceeding 30 atomic percent, the tin content may be relatively insufficient and it is difficult to exhibit the inherent characteristic properties of tin typified by high reflectivity effectively. In view of these advantages and disadvantages, the total content of at least one of the elements is more preferably 5 atomic percent or more and 25 atomic percent or less, and further preferably 10 atomic percent or more and 20 atomic percent or less.

Preferred examples of the elements belonging to Groups 4a, 5a, 6a, and 7a of the Periodic Table of Elements include Ti, Zr, and Hf as elements belonging to Group 4a; V, Nb, and Ta as elements belonging to Group 5a; Cr, Mo, and W as elements belonging to Group 6a; and Mn, Tc, and Re as elements belonging to Group 7a.

Neodymium (Nd) and yttrium (Y) which may be further contained in the tin-based alloys not only contribute to improvements in corrosion resistance and surface smoothness of the optical recording layer but also contribute to creation of recording marks with suitable dimensions to thereby reduce the jitter. Although these advantages are exhibited even in trace amounts, the total content of these elements is desirably 0.1 atomic percent or more, and more desirably 0.5 atomic percent or more for practically apparently exhibiting the advantages. However, when these elements are contained in excess, the tin content may be relatively insufficient, and it may be difficult to exhibit the inherent characteristic properties of tin. The total content of these elements is therefore preferably controlled to 10 atomic percent or less, and more preferably to 5 atomic percent or less.

The optical recording layer of tin-based alloy preferably has a thickness in the range of 1 to 50 nm so as to yield a recording layer capable of reliably recording data with a stable precision, while such preferred thickness may vary depending on the structure of the optical information storage medium. An optical recording layer having an excessively small thickness of less than 1 nm may be susceptible to defects such as pores on its surface and thereby fail to provide a satisfactory recording sensitivity, even if at least one of an optical control layer and a dielectric layer is arranged as an upper layer and/or an underlayer of the optical recording layer. In contrast, an optical recording layer having an excessively large thickness exceeding 50 nm may fail to create satisfactory recording marks, because heat generated by the application of laser beams may excessively rapidly diffuse in such a thick recording layer. From the viewpoint of reflectivity as an optical disc, the thickness of the recording layer is more preferably 8 nm or more and 30 nm or less, and further preferably 12 nm or more and 20 nm or less when neither dielectric layer nor optical control layer is arranged. The thickness is more preferably 3 nm or more and 30 nm or less, and further preferably 5 nm or more and 20 nm or less when at least one of a dielectric layer and an optical control layer is arranged.

A laser beam to be applied for the recording of information preferably has a wavelength of 350 to 700 nm. A laser beam having an excessively short wavelength less than 350 nm may be significantly absorbed typically by a covering layer (light transmission layer) and may not sufficiently contribute to the writing and reading of information on an optical recording layer. In contrast, a laser beam having an excessively long wavelength exceeding 700 nm may have insufficient energy and may not sufficiently contribute to the creation of recording marks on an optical recording layer. From these viewpoints, a laser beam for use in information recording may have a wavelength of more preferably 350 nm or more and 660 nm or less, and further preferably 380 nm or more and 650 nm or less.

A sputtering target (sputtering target according to the fifth embodiment) for the deposition of the recording layer according to the fifth embodiment may have a composition basically the same as a desired alloy composition of the recording layer. In other words, the recording layer having a desired alloy composition can be easily deposited by sputtering using a sputtering target having a composition as with the alloy composition of the recording layer.

Characteristic properties of tin-based alloys for use in the present invention will be illustrated in contrast with the known techniques.

When used in an optical recording layer, the tin-based alloys for use herein are slightly inferior in reflectivity to aluminum (Al), silver (Ag), and copper (Cu) disclosed in Patent Documents 1 to 4. The tin-based alloys, however, furthermore satisfactorily contribute to the creation of recording marks upon irradiation with a laser beam than these metals. This is probably because tin has a much lower melting point than those of aluminum (Al), silver (Ag), and copper (Cu), and a thin film of tin-based alloy readily melts or deforms upon irradiation with a laser beam to thereby exhibit excellent recording properties, as described above.

In particular, when used in a recording layer mainly aiming to be applied to next-generation optical discs using a blue-violet laser beam as irradiation light as in the present invention, an aluminum (Al) thin film, for example, may fail to create recording marks satisfactorily upon irradiation with a laser beam at a low power. The technique according to the present invention, however, will eliminate this possibility.

After investigations, the present inventors found that the tin-based alloys disclosed in Patent Documents 5 to 7 had the following disadvantages.

Patent Document 6 discloses an optical recording layer including an alloy of 40 percent by mass of tin (Sn), 55 percent by mass of indium (In), and 5 percent by mass of copper (Cu) and having a film thickness of 2 to 4 nm. This alloy contains, in terms of atomic percent, 53.5 atomic percent of indium, 37.7 atomic percent of tin and 8.8 atomic percent of copper. It is difficult, however, to yield a practically sufficient C/N ratio using this optical recording layer. The alloy layer disclosed in this patent document has a thickness of 2 to 4 nm. This thickness, however, is too small for the alloy composition to yield a practically sufficient reflectivity.

Patent Document 7 discloses a recording layer containing a Sn—Bi alloy in combination with a material more susceptible to oxidation than tin and bismuth. This alloy, however, fails to provide a C/N ratio and a recording sensitivity higher than those in tin-based alloy recording layers according to the present invention.

Patent Document 5 discloses an optical recording layer including a tin-based alloy. This tin-based alloy contains 84 atomic percent of tin (Sn), 10 atomic percent of zinc (Zn), and 6 atomic percent of antimony (Sb). Even this tin-based alloy, however, fails to provide a C/N ratio, a recording sensitivity, and a reflectivity higher than those in tin-based alloy recording layers according to the present invention.

These also demonstrate that optical recording layers according to the present invention are more useful than known equivalents.

FIGS. 3 to 6 depict schematic cross-sectional views showing write-once optical information storage media (optical discs) according to embodiments of the present invention byway of example. These storage media are configured to write and read data by applying a laser beam with a wavelength of 350 to 700 nm to a recording layer. The optical discs shown in FIGS. 3(A), 4(A), 5(A), 6(A), and 6(C) each have a convex recording site, and those shown in 3(B), 4(B), 5(B), 6(B), and 6(D) each have a concave recording site.

Each of optical discs 10 in FIG. 3 includes a substrate 1, an optical control layer 2, dielectric layers 3 and 5, a recording layer 4 arranged between the dielectric layer 3 and 5, and a light transmission layer 6. The dielectric layers 3 and 5 are provided to protect the recording layer 4, thereby allowing long-term storage of recorded information.

Each of optical discs 10 in FIG. 4 includes a substrate 1, a zeroth recording layer group (a group of layers including an optical control layer, a dielectric layer, and a recording layer) 7A, an intermediate layer 8, a first recording layer group (a group of layers including an optical control layer, a dielectric layer, and a recording layer) 7B, and a light transmission layer 6. FIG. 5 illustrates optical discs of a single-layer DVD-R, a single-layer DVD+R, or a single-layer HD DVD-R type. FIG. 4 illustrates optical discs of a double-layer DVD-R, a double-layer DVD+R, or a double-layer HD DVD-R type. These figures also show an intermediate layer 8 and an adhesive layer 9.

A group of layers constituting the zeroth and first recording layer groups 7A and 7B in FIGS. 4 and 6 may have a three-layer structure, a two-layer structure, or a single-layer structure including a recording layer alone. The three-layer structure may be a structure of, for example, (dielectric layer)/(recording layer)/(dielectric layer), (dielectric layer)/(recording layer)/(optical control layer), or (recording layer)/(dielectric layer)/(optical control layer) arranged in this order from above in the figures. The two-layer structure may be a structure of, for example, (recording layer)/(dielectric layer), (dielectric layer)/(recording layer), (recording layer)/(optical control layer), or (optical control layer)/(recording layer) arranged in this order from above in the figures.

The criterion of durability employed herein is defined as a condition that “the change in reflectivity upon irradiation with a blue laser beam having a wavelength of 405 nm is less than 15%, preferably less than 10%, when a sample including a substrate 1 and a recording layer 4 alone arranged thereon is maintained under conditions of a temperature of 80° C. and relative humidity of 85% for 96 hours”. The change in reflectivity due to deterioration of the recording layer (recording film) is more marked upon irradiation with a blue laser beam, because the blue laser beam has a shorter wavelength than that of a red laser beam. Accordingly, the durability of optical discs on which recording and reading of information has been performed using a blue laser beam is expected to be decreased compared with the case where a red laser beam is used. A recording layer to be applied to optical discs using blue laser should therefore have higher durability than known equivalents.

In this connection, the durability of optical discs was also examined in above-mentioned Patent Documents 1 and 7, but the durability was merely examined under conditions milder than the conditions specified herein. In Patent Document 6, a durability test was carried out by maintaining a sample at a temperature of 60° C. and relative humidity of 90% for 120 hours. Specifically, it is carried out at a temperature lower than that in the present invention. In Patent Document 1, a durability test was carried out by maintaining a sample at a temperature of 80° C. and relative humidity of 85% for 50 hours. Specifically, it is carried out for a time period shorter than that in the present invention. In both of these, no durability test under high temperature and high humidity conditions for a long term as in the present invention is carried out.

An optical disc as a representative embodiment of the present invention has a feature in that it uses a tin-based alloy satisfying the above requirements as a material for a recording layer 4 as shown in FIGS. 3 to 6. Materials for the substrate 1, the optical control layer 2, and the dielectric layers 3 and 5, and other components than the recording layer 4 are not particularly limited and can be selected as appropriate from among common or known materials.

Specifically, materials for the substrate include polycarbonate resins, norbornene resins, cyclic olefin copolymers, and amorphous polyolefins. Materials for the optical control layer include metals such as Ag, Au, Cu, Al, Ni, Cr, and Ti, and alloys of these metals. Materials for the dielectric layers include ZnS—SiO₂; oxides typically of Si, Al, Ti, Ta, Zr, and Cr; nitrides typically of Ge, Cr, Si, Al, Nb, Mo, Ti, and Zn; carbides typically of Ge, Cr, Si, Al, Ti, Zr, and Ta; fluorides typically of Si, Al, Mg, Ca, and La; and mixtures of these.

When at least one of an optical control layer and a dielectric layer is arranged to thereby increase the reflectivity as an optical disc as mentioned above, the thickness of the recording layer is preferably 1 to 50 nm, more preferably 3 to 30 nm, and further preferably 5 to 20 nm.

As an optical recording layer having the configuration as specified herein is used, a part or all of the optical control layer 2 and the dielectric layers 3 and 5 can be omitted. The thickness of the optical recording layer, if used as a single layer, is preferably 8 to 30 nm, and more preferably 12 to 20 nm.

The optical recording layer of tin-based alloy is preferably deposited by sputtering. Specifically, the alloy elements (elements belonging to Groups 4a, 5a, 6a, and 7a of the Periodic Table of Elements, platinum (Pt), dysprosium (Dy), samarium (Sm), and cerium (Ce), neodymium (Nd), and yttrium (Y)) used herein in addition to tin have specific solubility limits with respect to tin in thermal equilibrium. However, the alloy elements in a thin film deposited by sputtering are more uniformly distributed in tin matrix, and the resulting thin film has homogenous properties and is likely to have more stable optical properties and higher environmental resistance.

A target for use in sputtering is preferably composed of a tin-based alloy prepared by melting and casting (hereinafter also referred to as “ingot tin-based alloy target”). This is because such an ingot tin-based alloy target has a uniform crystal structure, shows a stable sputtering rate, and emits atoms at uniform angles. Thus, the target contributes to the deposition of a recording layer having a homogenous alloy composition, and this in turn contributes to the production of an optical disc being homogenous and having high performance.

During the preparation of a target typically by vacuum melting, trace amounts of impurities such as nitrogen, oxygen, and other gaseous components in atmosphere, and components of a melting furnace may contaminate the target. The component compositions of a recording layer and targets for use according to an embodiment of the present invention do not specify these inevitable trace components (impurities). Trace amounts of such inevitable impurities may be contained, as long as they do not adversely affect the advantages and properties obtained according to embodiments of the present invention.

### EXAMPLES

The present invention will be illustrated in further detail with reference to several experimental examples below. It should be noted, however, the following examples are never intended to limit the scope of the present invention, and appropriate modifications and variations without departing from the spirit and scope of the present invention set forth above and below fall within the technological scope of the present invention.

### Experimental Example 1

Experimental Example 1 relates to recording layers for optical information storage media according to the first embodiment of the present invention.

Preparation Example of Samples

Samples of various thin films of tin-based alloys including Sn—Nd alloy thin films, Sn—Gd alloy thin films, and Sn—La alloy thin films shown in Table 1 were deposited in the following manner, and these were examined for the initial reflectivity, creation of recording marks, and durability. For comparison, a pure tin thin film was deposited and was examined for the properties in the same way.

Deposition of Tin-based Alloy Thin Films and Pure Tin Thin Film

Each of a pure tin thin film and a series of thin films of tin-based alloys was deposited on a transparent polycarbonate substrate having a thickness of 0.6 mm and a diameter of 120 mm using a pure tin sputtering target. The thin films of tin-based alloys were deposited using a composited sputtering target with chips of alloy elements to be added on the pure tin sputtering target. Sputtering was carried out under conditions of an argon (Ar) gas flow rate of 30 sccm, an argon gas pressure of 2 mTorr, a direct-current (DC) sputtering power of 50 W, and abase pressure of 10⁻⁵ Torr or less. The thicknesses of the thin films of tin-based alloys were varied within the range in Table 1 by changing the sputtering duration in the range of 5 sec to 45 sec. The compositions of the resulting thin films of tin-based alloys were determined by inductively coupled plasma (ICP) mass spectrometry.

Creativity of Recording Marks

The above-prepared samples were each irradiated with a blue laser beam at a varying laser power under the following conditions to create recording marks. The laser beam was applied from the side of the tin-based alloy thin film.

Light source: Semiconductor laser having a wavelength of 405 nm

Spot size of laser: 0.8 μm in diameter

Beam speed: 10 m/s

The shapes of the created recording marks were observed with an optical microscope at a magnification of 1000 times, and the ratio of the area of created recording mark to the area of irradiated laser beam (area ratio) was calculated. A sample showing an area ratio of 85% or higher (“Very good” and “Good”) was accepted herein, and the creativity of recording marks was evaluated based on the following criteria:

Very good: An area ratio of 85% or more is obtained even when irradiated with a laser beam at a low laser power of 10 mW or more and 15 mW or less.

Good: An area ratio of 85% or more is obtained when irradiated with a laser beam at a laser power more than 15 mW and equal to or less than 25 mW.

Poor: An area ratio of 85% or more is not obtained even when irradiated with a laser beam at a laser power more than 25 mW.

Measurement of Initial Reflectivity

Absolute spectral reflectivities of the thin films immediately after deposition of the films by sputtering and before creation of recording marks were determined at measuring wavelengths ranging from 1000 to 250 nm with the Ultraviolet Visible-ray Spectrometer “V-570” of JASCO Corporation. A sample having an initial reflectivity more than 30% at a wavelength of 405 nm was accepted herein.

Measurement of Durability

The samples after the measurement of initial reflectivity as above were subjected to high temperature and high humidity tests in which the samples were maintained in an atmospheric environment of a temperature of 80° C. and relative humidity of 85% for 96 hours. The absolute spectral reflectivities of the samples after the test were measured in the same way as above. The difference in reflectivity at a wavelength of 405 nm between before and after the high temperature and high humidity test (reduction in reflectivity after the completion of the test) was calculated, and the durability was evaluated according to the following criteria. A sample having a rating of the high temperature and high humidity test when maintained for 96 hours of “Excellent”, “Very good”, or “Good” was accepted herein.

Excellent: Reduction in reflectivity is less than 10%.

Very good: Reduction in reflectivity is 10% or more and less than 15%.

Good: Reduction in reflectivity is 15% or more and less than 20%.

Poor: Reduction in reflectivity is 20% or more.

These results are together shown in Table 1.

In Table 1, Sample 1 uses the pure tin thin film, Samples 2 to 12 use the Sn—Nd thin films, Samples 13 to 20 use the Sn—Gd thin films, and Samples 21 to 27 use the Sn—La thin films, respectively.

TABLE 1

| | | Film | | Creativity of | | |
|---|---|---|---|---|---|---|
| | Composition | thickness | Initial | recording | Durability | |
| Sample | (atomic percent) | (nm) | reflectivity | marks | 48 hr | 96 hr |
| 1 | Sn | 30 | Good | Very good | Poor | Poor |
| 2 | Sn—0.5%Nd | 30 | Good | Very good | Poor | Poor |
| 3 | Sn—1%Nd | 30 | Good | Very good | Very good | Good |
| 4 | Sn—3%Nd | 30 | Good | Very good | Very good | Very good |
| 5 | Sn—3%Nd | 50 | Good | Good | Excellent | Very good |
| 6 | Sn—3%Nd | 70 | Good | Poor | Excellent | Excellent |
| 7 | Sn—5%Nd | 8 | Poor | Very good | Good | Very good |
| 8 | Sn—5%Nd | 12 | Good | Good | Very good | Very good |
| 9 | Sn—5%Nd | 30 | Good | Good | Excellent | Excellent |
| 10 | Sn—10%Nd | 30 | Good | Good | Excellent | Excellent |
| 11 | Sn—15%Nd | 30 | Good | Good | Very good | Very good |
| 12 | Sn—16%Nd | 30 | Poor | Good | Very good | Good |
| 13 | Sn—0.5%Gd | 30 | Good | Very good | Poor | Poor |
| 14 | Sn—1%Gd | 30 | Good | Very good | Very good | Good |
| 15 | Sn—3%Gd | 30 | Good | Very good | Excellent | Very good |
| 16 | Sn—5%Gd | 30 | Good | Good | Excellent | Excellent |
| 17 | Sn—10%Gd | 30 | Good | Good | Excellent | Excellent |
| 18 | Sn—12%Gd | 30 | Good | Good | Excellent | Very good |
| 19 | Sn—15%Gd | 30 | Good | Good | Very good | Very good |
| 20 | Sn—16%Gd | 30 | Poor | Good | Very good | Good |
| 21 | Sn—0.5%La | 30 | Good | Very good | Poor | Poor |
| 22 | Sn—1%La | 30 | Good | Very good | Good | Good |
| 23 | Sn—3%La | 30 | Good | Very good | Very good | Good |
| 24 | Sn—5%La | 30 | Good | Good | Very good | Very good |
| 25 | Sn—10%La | 30 | Good | Good | Excellent | Very good |
| 26 | Sn—15%La | 30 | Good | Good | Good | Good |
| 27 | Sn—16%La | 30 | Poor | Good | Good | Good |

Table 1 demonstrates as follows.

The Sn—Nd thin films (Samples 3 to 5 and Samples 8 to 11), Sn—Gd thin films (Samples 14 to 19), and Sn—La thin films (Samples to 26) satisfying the requirements herein not only have good recording properties such as excellent initial reflectivity and creativity of recording marks but also excel in durability.

In contrast, Sample 1 of the pure tin thin film is poor in durability.

Samples 2, 13, and 21 having excessively low contents of neodymium (Nd), gadolinium (Gd), and lanthanum (La), respectively, are poor in durability.

In contrast, Samples 12, 20, and 27 having excessively high contents of neodymium (Nd), gadolinium (Gd), and lanthanum (La), respectively, show insufficient initial reflectivity.

Among the samples of Sn—Nd thin films, Sample 6 having a relatively large thickness of the thin film shows poor creation of recording marks; and Sample 7 having a relatively small thickness of the thin film shows a decreased initial reflectivity. Table shows only the results of tests in which the thicknesses of Sn—Nd thin films were varied. However, the present inventors have verified that similar results are obtained also upon Sn—Gd thin films and Sn—La thin films (not shown in Table 1).

### Experimental Example 2

Experimental Example 2 relates to recording layers for optical information storage media according to the second embodiment of the present invention.

Preparation Example of Samples

Samples of various thin films of tin-based alloys including Sn—B alloy thin films, Sn—B—Y alloy thin films, and Sn—B—In alloy thin films shown in Table 2 were deposited in the following manner, and these were examined for the initial reflectivity, creativity of recording marks, durability, surface roughness Ra, and media noise. For comparison, a pure tin thin film was deposited and was examined for the properties in the same way.

Deposition of Tin-based Alloy Thin Films and Pure Tin Thin Film

Each of a pure tin thin film and a series of thin films of tin-based alloys was deposited on a transparent polycarbonate substrate having a thickness of 0.6 mm and a diameter of 120 mm using a pure tin sputtering target. The thin films of tin-based alloys were deposited using a composited sputtering target with chips of alloy elements to be added on the pure tin sputtering target. The resulting thin films each had a thickness of 25 nm. Sputtering was carried out under conditions of an argon gas flow rate of 30 sccm, an argon gas pressure of 2 mTorr, a direct-current (DC) sputtering power of 50 W, a base pressure of 10⁻⁵ Torr or less, and a sputtering duration in the range of 6 sec to 30 sec. The compositions of the resulting thin films of tin-based alloys were determined by inductively coupled plasma (ICP) mass spectrometry and ICP emission spectrometry.

Creativity of Recording Marks

The above-prepared samples were each irradiated with a blue-violet laser beam at a varying laser power under the following conditions to create recording marks. The laser beam was applied from the side of the tin-based alloy thin film.

Light source: Semiconductor laser having a wavelength of 405 nm

Spot size of laser: 0.8 μm in diameter

Beam speed: 10 m/s

The shapes of the thus-created recording marks were observed with an optical microscope at a magnification of 1000 times, and the ratio of the area of created recording mark to the area of irradiated laser beam (area ratio) was calculated. A sample showing an area ratio of 85% or higher (“Very good” and “Good”) was accepted herein, and the creativity of recording marks was evaluated based on the following criteria:

Very good: An area ratio of 85% or more is obtained even when irradiated with a laser beam at a low laser power of 10 mW or more and 15 mW or less.

Good: An area ratio of 85% or more is obtained when irradiated with a laser beam at a laser power more than 15 mW and equal to or less than 25 mW.

Poor: An area ratio of 85% or more is not obtained even when irradiated with a laser beam at a laser power more than 25 mW.

Measurement of Initial Reflectivity

Absolute spectral reflectivities of the thin films immediately after deposition of the films by sputtering and before creation of recording marks were measured at measuring wavelengths ranging from 1000 to 250 nm with the Ultraviolet and Visible Ray Spectrometer “V-570” of JASCO Corporation. A sample having an initial reflectivity more than 30% at a wavelength of 405 nm was accepted herein.

Measurement of Durability

The samples after the measurement of initial reflectivity as above were subjected to high temperature and high humidity tests in which the samples were maintained in an atmospheric environment of a temperature of 80° C. and relative humidity of 85% for 96 hours. The absolute spectral reflectivities of the samples after the tests were measured in the same way as above. The difference in reflectivity at a wavelength of 405 nm between before and after the high temperature and high humidity test (reduction in reflectivity after the completion of the test) was calculated, and the durability was evaluated according to the following criteria. A sample having a rating of the high temperature and high humidity test when maintained for 96 hours of “Excellent”, “Very good”, or “Good” was accepted herein.

Excellent: Reduction in reflectivity is less than 10%.

Very good: Reduction in reflectivity is 10% or more and less than 15%.

Good: Reduction in reflectivity is 15% or more and less than 20%.

Poor: Reduction in reflectivity is 20% or more.

Measurement of Surface Roughness Ra

Surface roughness Ra of the samples bearing deposited recording layers were measured according to the above-mentioned procedure, and were evaluated according to the following criteria. A sample evaluated as being “Good” or “Very good” in surface roughness Ra was accepted herein. As demonstrated in Table 1, a sample evaluated as being “Good” or “Very good” in surface roughness Ra is also evaluated as “Good” or “Very good” in media noise mentioned later.

Very good: Surface roughness Ra is less than 2.0 nm

Good: Surface roughness Ra is 2.0 nm or more and 4.0 nm or less

Poor: Surface roughness Ra is more than 4.0 nm

Measurement of Noise

The media noise of the samples bearing recording layers was measured at a beam speed of 5.2 m/s and a frequency of 16.5 MHz with a disc evaluation unit (product of Pulstec Industrial Co., Ltd. under the trade name of “ODU-1000”) and a spectrum analyzer (product of Advantest Corporation under the trade name of “R3131A”) The measured noise was evaluated according to the following criteria. A sample evaluated as being “Good” or “Very good” in noise was accepted herein. A sample evaluated as being “Good” or “Very good” in noise has a C/N ratio of 40 dB or more and sufficiently satisfies a required level as an optical disc.

Very good: Noise is less than −75 dB

Good: Noise is −75 dB or more and −65 dB or less

Poor: Noise is more than −65 dB These results are together shown in Table 2.

In Table 2, Sample 1 uses the pure tin thin film, Samples 2 to 8 use the Sn—B thin films, Samples 9 to 17 use the Sn—B—Y thin films, and Samples 18 to 24 use the Sn—B—In thin films.

TABLE 2

| | | | Surface | | Creativity of | |
|---|---|---|---|---|---|---|
| | Composition | Initial | roughness | | recording | |
| Sample | (atomic percent) | reflectivity | Ra (nm) | Media noise | marks | Durability |
| 1 | Sn | Very good | Poor | Poor | Very good | Poor |
| 2 | Sn—1%B | Very good | Good | Good | Very good | Good |
| 3 | Sn—2%B | Very good | Good | Good | Very good | Good |
| 4 | Sn—5%B | Very good | Good | Good | Very good | Good |
| 5 | Sn—10%B | Very good | Very good | Very good | Very good | Good |
| 6 | Sn—20%B | Very good | Very good | Very good | Good | Good |
| 7 | Sn—30%B | Very good | Very good | Very good | Good | Good |
| 8 | Sn—35%B | Poor | Very good | Very good | Good | Good |
| 9 | Sn—2%B—0.5%Y | Very good | Good | Good | Very good | Good |
| 10 | Sn—2%B—1%Y | Very good | Good | Good | Very good | Very good |
| 11 | Sn—2%B—5%Y | Good | Very good | Very good | Good | Very good |
| 12 | Sn—2%B—15%Y | Good | Very good | Very good | Good | Excellent |
| 13 | Sn—2%B—16%Y | Poor | Very good | Very good | Good | Excellent |
| 14 | Sn—5%B—2%Y | Very good | Good | Good | Very good | Very good |
| 15 | Sn—10%B—2%Y | Very good | Good | Good | Very good | Very good |
| 16 | Sn—16%B—2%Y | Good | Very good | Very good | Very good | Very good |
| 17 | Sn—20%B—2%Y | Very good | Very good | Very good | Good | Very good |
| 18 | Sn—5%B—3%In | Very good | Good | Good | Very good | Good |
| 19 | Sn—5%B—5%In | Very good | Good | Good | Very good | Very good |
| 20 | Sn—10%B—10%In | Very good | Good | Good | Very good | Very good |
| 21 | Sn—20%B—10%In | Very good | Very good | Very good | Good | Very good |
| 22 | Sn—20%B—20%In | Good | Very good | Very good | Good | Excellent |
| 23 | Sn—20%B—50%In | Good | Very good | Very good | Good | Excellent |
| 24 | Sn—20%B—55%In | Poor | Very good | Very good | Good | Excellent |

Table 2 demonstrates as follows.

The Sn—B thin films (Samples 2 to 7) satisfying the requirements herein excel in initial reflectivity and creativity of recording marks. They show low noise and thereby have high C/N ratios.

The Sn—B—Y thin films (Samples 10 to 12 and 14 to 17) further contain specific amounts of yttrium (Y) as element(s) belonging to Group Z, and the Sn—B—In thin films (Samples 19 to 23) further contain specific amounts of indium (In), respectively, in addition to the compositions of Sn—B alloys. These thin films have further increased durability while maintaining the good recording properties and low noise as in the Sn—B alloys.

In contrast, Sample 1 of the pure tin thin film has a large surface roughness Ra, and is poor in noise and durability.

Sample 8 (Sn—B alloy) with a large boron content is poor in initial reflectivity.

In contrast, Sample 9 (Sn—B—Y alloy) with a small yttrium content and Sample 18 (Sn—B—In alloy) with a small indium content do not achieve sufficiently effectively improved durability as desired and show durability equivalent to that of the corresponding Sn—B alloy. For effectively improving the corrosion resistance, the lower limit of the indium content is preferably 5 atomic percent, and the lower limit of the yttrium (element(s) belonging to Group Z) content is preferably 1.0 atomic percent.

Sample 13 (Sn—B—Y alloy) with a large yttrium content and Sample 24 (Sn—B—In alloy) with a large indium content are poor in initial reflectivity to the corresponding Sn—B alloy, although they are excellent in durability.

Table 2 shows the results in tests of the Sn—B—Y thin films containing yttrium as the element(s) belonging to Group Z by way of example. The element(s) belonging to Group Z is not limited to yttrium, and the present inventors have verified that similar results are obtained also upon thin films containing, as additional element(s), the other elements belonging to Group Z (La, Nd, and Gd) (not shown in Table 2).

The average grain diameters of the thin films are not shown in Table 2. However, it has been verified that thin films evaluated as being “Good” or “Very good” in noise have small average grain diameters of 60 nm or less (not shown in Table 1).

### EXPERIMENTAL EXAMPLES 3 To 5

Experimental Examples 3 to 5 below relate to recording layers for optical information storage media according to the third embodiment of the present invention.

### EXPERIMENTAL EXAMPLE 3

This experimental example relates to optical recording layers of Sn—Ni alloys, Sn—Ni—In alloys, Sn—Ni-(rare-earth element) alloys and Sn—Ni—In—Y alloys. In this connection, experiments were made in the same way on optical recording layers including Sn—Co alloys and Sn—Ni—{Bi, Zn} alloys, respectively, and no substantial difference was found in the experimental results.

(1) Preparation of Discs

Optical recording layers were deposited each on a disc substrate by direct-current (DC) sputtering using sputtering targets. The disc substrate was a polycarbonate substrate having a thickness of 1.1 mm, a track pitch of 0.32 μm, a groove width of 0.14 to 0.16 μm, and a groove depth of 25 nm. The sputtering targets were composited targets each including a 6-inch tin target with chips of an element to be alloyed arranged on the tin target.

The sputtering for the deposition of optical recording layers was conducted under conditions of a base pressure of 10⁻⁵ Torr or less (1 Torr equals 133.3 Pa), an argon (Ar) gas pressure of 4 mTorr, and a DC sputtering power of 100 W. The thicknesses of the recording layers were varied by changing the sputtering duration in the range of 5 sec to 120 sec.

Next, a film of an ultraviolet-curable resin (product of Nippon Kayaku Co., Ltd. under the trade name of “BRD-130”) was applied to the recording layer by spin coating, the applied film was irradiated with and cured by ultraviolet rays and thereby yielded a light transmission layer having a thickness of 100±15 μm.

(2) Evaluation Methods of Optical Discs

Properties of the optical discs were determined at a beam speed of 5.28 m/s with an optical disc drive evaluation unit and a spectrum analyzer. The optical disc drive evaluation unit was a product of Pulstec Industrial Co., Ltd. under the trade name of “ODU-1000”, having a recording laser wavelength of 405 nm and a numerical aperture (NA) of 0.85. The spectrum analyzer was a product of Advantest Corporation under the trade name of “R3131R”. The determined properties were (1) a noise level of an unrecorded disc at a frequency of 16.5 MHz; (2) a C/N ratio at a frequency of 16.5 MHz where 2T rectangular pulses were recorded on a disc; (3) a recording sensitivity at such a recording laser power as to yield a maximum C/N ratio; and (4) a reflectivity as a disc. The reflectivity as a disc was determined assuming that a SUM2 level of 320 mV corresponds to a reflectivity of 16%. This assumption was based on the measured result of a SUM2 level of a commercially available Blu-ray Disc rewritable (BD-RE).

The results are together shown in Table 3. Criteria for the properties in Table 3 are as follows.

(1) Noise Level of Unrecorded Disc

Excellent: Noise level is less than −75 dB;

Very good: Noise level is −75 dB or more and less than −70 dB;

Good: Noise level is −70 dB or more and less than −65 dB;

Poor: Noise level is −65 dB or more

(2) C/N Ratio

Excellent: C/N ratio is more than 45 dB;

Very good: C/N ratio is 40 dB or more and less than 45 dB;

Good: C/N ratio is 35 dB or more and less than 40 dB;

Poor: C/N ratio is less than 35 dB

(3) Recording Sensitivity

Excellent: Recording sensitivity is less than 10 mW;

Very good: Recording sensitivity is 10 mW or more and less than 15 mW;

Good: Recording sensitivity is 15 mW or more and less than mW;

Poor: Recording sensitivity is 20 mW or more

(4) Reflectivity

Very good: Reflectivity is 15% or more and 22% or less;

Good: Reflectivity is 10% or more and less than 15%, or more than 22% and less than 30%;

Poor: Reflectivity is less than 10%, or 30% or more

The compositions of the deposited optical recording layers were determined by inductively coupled plasma (ICP) emission spectrometry and mass spectrometry.

TABLE 3

| | | Film | | | | |
|---|---|---|---|---|---|---|
| Sample | Composition | thickness | | | Recording | |
| Number | (atomic percent) | (nm) | Noise | C/N ratio | sensitivity | Reflectivity |
| Sample 1 | Sn—1Ni | 12 | Good | Good | Excellent | Good |
| Sample 2 | Sn—5Ni | 12 | Good | Very good | Excellent | Good |
| Sample 3 | Sn—10Ni | 12 | Good | Excellent | Very good | Very good |
| Sample 4 | Sn—15Ni | 12 | Very good | Excellent | Very good | Very good |
| Sample 5 | Sn—25Ni | 12 | Very good | Excellent | Very good | Very good |
| Sample 6 | Sn—35Ni | 12 | Excellent | Excellent | Good | Very good |
| Sample 7 | Sn—50Ni | 12 | Excellent | Excellent | Good | Good |
| Sample 8 | Sn—15Ni | 8 | Excellent | Excellent | Excellent | Good |
| Sample 9 | Sn—15Ni | 20 | Excellent | Excellent | Very good | Very good |
| Sample 10 | Sn—15Ni | 30 | Very good | Very good | Very good | Very good |
| Sample 11 | Sn—15Ni | 50 | Good | Good | Good | Very good |
| Sample 12 | Sn—15Ni—3In | 12 | Very good | Excellent | Very good | Very good |
| Sample 13 | Sn—15Ni—6In | 12 | Very good | Excellent | Very good | Very good |
| Sample 14 | Sn—15Ni—25In | 12 | Very good | Very good | Excellent | Good |
| Sample 15 | Sn—15Ni—30In | 12 | Good | Good | Excellent | Good |
| Sample 16 | Sn—15Ni—0.5Y | 12 | Excellent | Excellent | Very good | Very good |
| Sample 17 | Sn—15Ni—1.0Y | 12 | Excellent | Excellent | Very good | Very good |
| Sample 18 | Sn—15Ni—8Y | 12 | Excellent | Excellent | Very good | Very good |
| Sample 19 | Sn—15Ni—10Y | 12 | Excellent | Excellent | Very good | Good |
| Sample 20 | Sn—5Ni—5Y | 12 | Excellent | Excellent | Excellent | Good |
| Sample 21 | Sn—5Ni—5Nd | 12 | Very good | Very good | Excellent | Good |
| Sample 22 | Sn—20Ni—8In—2Y | 12 | Excellent | Excellent | Excellent | Good |
| Sample 23 | Sn | 12 | Poor | Poor | Excellent | Good |
| Sample 24 | Sn—55Ni | 12 | Excellent | Excellent | Poor | Good |
| Sample 25 | Sn—15Ni | 5 | Excellent | Excellent | Excellent | Poor |
| Sample 26 | Sn—15Ni | 60 | Excellent | Excellent | Poor | Very good |
| Sample 27 | Sn—15Ni—40In | 12 | Good | Good | Excellent | Poor |
| Sample 28 | Sn—15Ni—15Y | 12 | Excellent | Excellent | Good | Poor |

Table 3 demonstrates that the noise decreases and the C/N ratio increases with an increasing nickel content. This is because the surface smoothness of the optical recording layer is improved with an increasing nickel content. The samples having nickel contents in the range of 15 to 25 atomic percent show excellent properties in all the measured properties.

The addition of a rare-earth element further improves the surface smoothness and corrosion resistance. In particular, in reading waveforms, the thin film of an alloy containing Sn, 5 atomic percent of Ni, and 5 atomic percent of Y shows less noise component than that of the thin film of an alloy containing Sn, 5 atomic percent of Ni, and 5 atomic percent of Nd.

As a comprehensive evaluation, these results demonstrate that the optical recording layers (Samples Nos. 1 to 22) satisfying the requirements specified herein have properties superior to those of the optical recording layers (Samples Nos. 23 to 28) not satisfying the requirements specified herein.

### EXPERIMENTAL EXAMPLE 4

A series of discs were prepared using the optical recording layer of an alloy containing Sn, 15 atomic percent of Ni, and 3 atomic percent of Y as deposited according to Experimental Example 3, in which a dielectric layer was further arranged by radio frequency sputtering with a 4-inch ZnS—SiO₂ target. The dielectric layer was arranged as an upper layer or as an underlayer of the optical recording layer. In the former case, the dielectric layer was deposited next to the recording layer, namely the dielectric layer was positioned between the recording layer and a covering layer. In the latter case, the dielectric layer was deposited on a substrate, and a recording layer was then deposited thereon, namely, the dielectric layer was positioned between the substrate and the recording layer. Evaluations of the discs were performed in the same manner as in Experimental Example 1. The sputtering was carried out under conditions of a base pressure of 10⁻⁵ Torr or less, an argon (Ar) gas pressure of 2 mTorr, and a radio frequency sputtering power of 200 W. The thicknesses of the dielectric layers were controlled by changing the sputtering duration in the range of 5 sec to 120 sec.

The results are together shown in Table 4. The criteria in Table 4 are as defined in Table 3.

TABLE 4

| | | Thickness of dielectric | | | | | |
|---|---|---|---|---|---|---|---|
| | Thickness of | layer (nm) | | | | | |
| Sample | recording | Upper | | | | Recording | |
| Number | layer (nm) | layer | Underlayer | Noise | C/N | sensitivity | Reflectivity |
| Sample 1 | 3 | 40 | 0 | Good | Good | Excellent | Good |
| Sample 2 | 5 | 40 | 0 | Good | Very good | Excellent | Good |
| Sample 3 | 3 | 0 | 5 | Good | Very good | Excellent | Good |
| Sample 4 | 5 | 0 | 5 | Excellent | Excellent | Excellent | Very good |
| Sample 5 | 5 | 0 | 10 | Excellent | Excellent | Excellent | Very good |
| Sample 6 | 5 | 0 | 25 | Excellent | Excellent | Very good | Excellent |
| Sample 7 | 5 | 0 | 50 | Excellent | Excellent | Good | Excellent |
| Sample 8 | 5 | 10 | 0 | Excellent | Excellent | Excellent | Good |
| Sample 9 | 5 | 20 | 0 | Excellent | Excellent | Excellent | Very good |
| Sample 10 | 5 | 40 | 0 | Excellent | Excellent | Excellent | Excellent |
| Sample 11 | 10 | 0 | 5 | Excellent | Excellent | Very good | Very good |
| Sample 12 | 10 | 0 | 10 | Excellent | Excellent | Very good | Excellent |
| Sample 13 | 10 | 0 | 20 | Excellent | Excellent | Very good | Excellent |
| Sample 14 | 10 | 40 | 0 | Excellent | Excellent | Very good | Excellent |
| Sample 15 | 10 | 40 | 5 | Excellent | Excellent | Excellent | Excellent |

As is demonstrated in Table 4, the arrangement of a dielectric layer increases the reflectivity as a disc and thereby allows the recording layer to have a relatively small thickness. This improves the balance among “noise”, “C/N ratio”, and “recording sensitivity”.

### EXPERIMENTAL EXAMPLE 5

Environmental resistance (durability) tests were performed on the samples in Experimental Examples 3 and 4. The criterion in the environmental resistance (durability) is defined as a condition that “the change in reflectivity upon irradiation with a blue laser beam having a wavelength of 405 nm is less than 15%, preferably less than 10%, when a sample including an exposed recording layer without a light transmission layer is maintained under conditions of a temperature of 80° C. and relative humidity of 85% for 96 hours”. Spectral absolute reflectivities were measured with the Ultraviolet and Visible Ray Spectrometer “V-570” of JASCO Corporation in these tests. All optical recording layers satisfying the requirements specified herein were found to satisfy the criterion in the environmental resistance (durability).

### EXPERIMENTAL EXAMPLES 6 AND 7

Following Experimental Examples 6 and 7 relate to recording layers for optical information storage media according to the fourth embodiment of the present invention.

### EXPERIMENTAL EXAMPLE 6

This experimental example relates to optical information recording layers of Sn-(rare-earth element) alloys and Sn-(rare-earth element)-In alloys. In this connection, experiments were made in the same way on recording layers including Sn-(rare-earth element)-Bi alloys and Sn-(rare-earth element)-In—Bi alloys, respectively, and no substantial difference was found in the experimental results.

(1) Preparation of Discs

A series of recording layers 4 having a thickness of 10 to 25 nm was deposited on a disc substrate 1 by direct-current (DC) sputtering using sputtering targets. The disc substrate 1 was a polycarbonate substrate having a thickness of 1.1 mm, a track pitch of 0.32 μm, a groove width of 0.14 to 0.16 μm, and a groove depth of 25 nm. Sputtering targets were composited targets each including a 6-inch tin target with chips of an element to be alloyed arranged on the tin target.

The sputtering for the deposition of optical recording layers was conducted under conditions of a base pressure of 10⁻⁵ Torr or less (1 Torr equals 133.3 Pa), an argon (Ar) gas pressure of 4 mTorr, and a DC sputtering power of 100 W. The thicknesses of the recording layers were varied by changing the sputtering duration in the range of 5 sec to 120 sec so as to give a reflectivity of 40%.

A protective layer (dielectric layer) 5 was deposited on each of the recording layers by radio frequency sputtering with a ZnS—SiO₂ target. The sputtering for the deposition of the protective layer was conducted under conditions of a base pressure of 10⁻⁵ Torr or less, an argon (Ar) gas pressure of 2 mTorr, and a radio frequency sputtering power of 200 W. The resulting protective layer had a thickness of 20 nm.

Next, a film of an ultraviolet-curable resin (product of Nippon Kayaku Co., Ltd. under the trade name of “BRD-130”) was applied thereto by spin coating, the applied film was irradiated with and cured by ultraviolet rays and thereby yielded a light transmission layer 6 having a thickness of 100±15 μm.

(2) Evaluation Methods of Optical Discs

Carrier to noise (C/N) ratios upon signal reading of the optical discs were measured with an optical disc drive evaluation unit and a spectrum analyzer. Specifically, recording marks each having a length of 0.13 μm were repeatedly created at a laser power of 7 mW and a beam speed of 5.3 m/s. These signals were read out at a laser power of 0.3 mW, and the C/N ratios were determined. The optical disc drive evaluation unit was a product of Pulstec Industrial Co., Ltd. under the trade name of “ODU-1000”, having a recording laser wavelength of 405 nm and a numerical aperture (NA) of 0.85. The spectrum analyzer was a product of Advantest Corporation under the trade name of “R3131R”.

Environmental resistance (durability) tests were conducted in the following manner. Optical discs to be tested were prepared in the same way as above by depositing a film of a tin-based alloy as a recording layer on a polycarbonate substrate by sputtering, except for not carrying out the formation of a protective layer from an ultraviolet curable resin. These optical discs were maintained in a thermo-hygrostat testing chamber at a temperature of 80° C. and relative humidity of 85% for 96 hours, and the changes in reflectivity upon irradiation with a laser beam having a wavelength of 405 nm before and after the tests were measured with a spectrophotometer (product of JASCO Corporation under the trade name of “V-570”).

The results are together shown in Table 5. A sample showing noise of −55 dB or less was accepted; one having a C/N ratio of dB or more was accepted; and one having a reflectivity change (environmental resistance) of 15% or less was accepted. The practical utilities of the samples were evaluated based on the noise, C/N ratio, and change in reflectivity (environmental resistance). Samples being accepted in at least one of the noise and C/N ratio were evaluated as having practical properties and being “Accepted”, and the others were evaluated as being “Failed”.

TABLE 5

| | | | | Change in | |
|---|---|---|---|---|---|
| Sample | Composition | Noise | C/N | reflectivity | |
| Number | (atomic percent) | (dBm) | (dBm) | (%) | Evaluation |
| 1 | Sn—0.5Nd | −48.6 | 31.2 | −25 | Failed |
| 2 | Sn—1Nd | −56.2 | 40.8 | −16.5 | Accepted |
| 3 | Sn—5Nd | −64.6 | 41.3 | −13.2 | Accepted |
| 4 | Sn—15Nd | −69.2 | 43.2 | −8.9 | Accepted |
| 5 | Sn—20Nd | −71.3 | 36.2 | −7.6 | Failed |
| 6 | Sn—5Y | −71.3 | 42 | −12.6 | Accepted |
| 7 | Sn—5La | −64.3 | 41.6 | −18.3 | Accepted |
| 8 | Sn—5Gd | −67.2 | 40.8 | −15.3 | Accepted |
| 9 | Sn—5Dy | −68.3 | 42.2 | −14.5 | Accepted |
| 10 | Sn—5Nd—1In | −64.8 | 40.8 | −12.8 | Accepted |
| 11 | Sn—5Nd—5In | −66.2 | 42.8 | −8.8 | Accepted |
| 12 | Sn—5Nd—20In | −66.8 | 43.9 | −6.5 | Accepted |
| 13 | Sn—5Nd—50In | −67 | 41.5 | −5.3 | Accepted |
| 14 | Sn—5Y—20In | −72.8 | 40.8 | −7.2 | Accepted |
| 15 | Sn—5La—20In | −66.4 | 43.2 | −8.6 | Accepted |
| 16 | Sn—5Gd—20In | −69.2 | 42 | −9.1 | Accepted |
| 17 | Sn—5Dy—20In | −68.5 | 46.2 | −9.4 | Accepted |

As is demonstrated in Table 5, tin-based alloys containing 1 atomic percent to 15 atomic percent of a rare-earth element show reduced noise of −55 dBm or less. If the content of a rare-earth element is less than 1 atomic percent, the noise reduction is insufficient. If it exceeds 15 atomic percent, the C/N ratio is lowered.

In addition, the Sn-(rare-earth element) alloys further containing indium (In) shows considerably improved environmental resistance, of which those containing 3 atomic percent or more of indium show smaller changes in reflectivity of 10% or less.

### EXPERIMENTAL EXAMPLE 7

A series of discs was prepared in the same way as in the recording layer deposited in Experimental Example 6, except that protective layers (dielectric layers) 3 and 5 were further deposited as an upper layer and an underlayer of a recording layer by radio frequency sputtering with a 4-inch ZnS—SiO₂ target. The protective layer as the upper layer was deposited next to a recording layer, namely the dielectric layer was positioned between the recording layer and a covering layer. The protective layer as the underlayer was deposited on a substrate, and a recording layer was then deposited thereon, namely, the dielectric layer was positioned between the substrate and the recording layer. The sputtering for the deposition of the protective layer was carried out under conditions of a base pressure of 10⁻⁵ Torr or less, an argon (Ar) gas pressure of 2 mTorr, and a radio frequency sputtering power of 200 W. The thicknesses of the protective layers were controlled by changing the sputtering duration in the range of 5 sec to 120 sec.

The results are shown in Table 6, demonstrating that the arrangement of protective layers (dielectric layers) adjacent to the recording layer suppresses increase of noise in recording and markedly improves the C/N ratio.

TABLE 6

| | | Thickness of | Thickness of | Thickness of | |
|---|---|---|---|---|---|
| Sample | Alloy composition | protective layer 5 | recording layer 4 | protective layer 3 | C/N |
| Number | (atomic percent) | (nm) | (nm) | (nm) | (dBm) |
| 1 | Sn—5Nd—20In | 0 | 20 | 0 | 43.9 |
| 2 | Sn—5Nd—20In | 20 | 20 | 0 | 48.5 |
| 3 | Sn—5Nd—20In | 20 | 20 | 10 | 49.6 |
| 4 | Sn—5Nd—20In | 0 | 20 | 10 | 47.4 |

### EXPERIMENTAL EXAMPLE 8

Following Experimental Example 8 relates to recording layers for optical information storage media according to the fifth embodiment of the present invention.

(1) Preparation of Discs

A series of optical recording layers was deposited on a disc substrate by DC sputtering. The disc substrate was a polycarbonate substrate having a thickness of 0.6 mm and a diameter of 120 mm. Sputtering targets were composited targets each including a 4-inch tin target with chips of an element to be alloyed arranged on the tin target.

The sputtering for the deposition of the optical recording layers was carried out under conditions of a base pressure of 10⁻⁵ Torr or less (1 Torr equals 133.3 Pa), an argon gas flow rate of 30 sccm, an argon gas pressure of 2 mTorr, and a DC sputtering power of 50 W. The thicknesses of the recording layers were varied by changing the sputtering duration in the range of 5 sec to 45 sec. The compositions of the resulting tin-based alloy layers were determined by inductively coupled plasma (ICP) emission spectrometry and mass spectrometry.

(2) Evaluation Methods of Optical Discs

The laser power at which good recording marks were created on a sample recording layer was determined at a beam speed of 10 m/s using an optical disc evaluation system (product of Hitachi Computer Peripherals Co., Ltd. under the trade name of “POP-120-8R”). The laser beam was applied from semiconductor laser having a wavelength of 405 nm as a light source at a laser spot size of 0.8 μm in diameter. It was applied from the side of the recording layer. The resulting mark was observed under an optical microscope, and the areal ratio of the area of the mark to the area of irradiated laser beam was determined by image processing analysis and calculation. A sample having an area ratio of 85% or more was accepted herein.

An absolute reflectivity of a sample recording layer deposited on a polycarbonate resin substrate was measured with the V-570 Ultraviolet and Visible Ray Spectrometer (JASCO Corporation), and this was defined as the reflectivity.

The corrosion resistance of a sample was determined by maintaining the sample in the atmosphere at a temperature of 80° C. and relative humidity of 85% for 96 hours, measuring a reflectivity, and reduction in reflectivity as compared with the reflectivity before the test (AR; in unit of percent) was calculated.

The surface roughness (Ra; in unit of nanometer (nm)) was measured in a measuring area of 2.5 μm long and 2.5 μm wide with an atomic force microscope (product of Seiko Instruments Inc. under the trade names of “SPI 4000” Probe Station) in AFM mode.

The results are together shown in Table 7. The criteria of properties in Table 7 are as follows.

(1) Initial Reflectivity

Good: Initial reflectivity is 30% or more,

Poor: Initial reflectivity is less than 30%

(2) Laser Power to Create Recoding Marks

Very good: Laser power required to create recording marks is 10 mW or more and 15 mW or less,

Good: Laser power required to create recording marks is more than 15 mW and 25 mW or less,

Poor: Laser power required to create recording marks is more than 25 mW

(3) Corrosion Resistance (change in reflectivity ΔR)

Excellent: Change in reflectivity ΔR is less than 10%,

Very good: Change in reflectivity ΔR is 10% or more and less than 15%,

Good: Change in reflectivity ΔR is 15% or more and less than 20%,

Poor: Change in reflectivity ΔR is 20% or more.

(4) Surface Roughness (Ra)

Very good: Surface roughness Ra is less than 2.0 nm,

Good: Surface roughness Ra is 2.0 nm or more and 4.0 nm or less,

Poor: Surface roughness Ra is more than 4.0 nm

TABLE 7

| | | | | | Laser power | Corrosion | |
|---|---|---|---|---|---|---|---|
| | Composition | Group of | Film | | to create | resistance | Surface |
| Sample | (atomic | alloyed | thickness | Initial | recording | (change in | roughness |
| Number | percent) | element | (nm) | reflectivity | marks | reflectivity ΔR) | (Ra) |
| 1 | Sn—2Ti | IVa | 30 | Good | Very good | Good | Good |
| 2 | Sn—10Ti | IVa | 30 | Good | Very good | Very good | Good |
| 3 | Sn—30Ti | IVa | 30 | Good | Good | Excellent | Very good |
| 4 | Sn—10Ti | IVa | 10 | Good | Very good | Good | Very good |
| 5 | Sn—10Ti | IVa | 50 | Good | Good | Excellent | Good |
| 6 | Sn—5Ta | Va | 30 | Good | Very good | Good | Good |
| 7 | Sn—15Ta | Va | 30 | Good | Good | Very good | Good |
| 8 | Sn—10V | Va | 30 | Good | Very good | Excellent | Good |
| 9 | Sn—20V | Va | 30 | Good | Good | Excellent | Good |
| 10 | Sn—20Hf | IVa | 30 | Good | Good | Very good | Good |
| 11 | Sn—30Cr | VIa | 30 | Good | Good | Excellent | Very good |
| 12 | Sn—20Mn | VIIa | 30 | Good | Good | Very good | Good |
| 13 | Sn—10Pt | VIII | 30 | Good | Very good | Good | Very good |
| 14 | Sn—20Pt | VIII | 30 | Good | Very good | Good | Very good |
| 15 | Sn—2Dy | lanthanum | 30 | Good | Very good | Very good | Good |
| | | series | | | | | |
| 16 | Sn—10Dy | lanthanum | 30 | Good | Good | Excellent | Very good |
| | | series | | | | | |
| 17 | Sn—2Sm | lanthanum | 30 | Good | Very good | Good | Good |
| | | series | | | | | |
| 18 | Sn—10Sm | lanthanum | 30 | Good | Good | Excellent | Good |
| | | series | | | | | |
| 19 | Sn—2Ce | lanthanum | 30 | Good | Very good | Good | Good |
| | | series | | | | | |
| 20 | Sn—10Ce | lanthanum | 30 | Good | Good | Excellent | Very good |
| | | series | | | | | |
| 21 | Sn—10Ti—5Y | — | 30 | Good | Very good | Very good | Very good |
| 22 | Sn—15Ta—5Nd | — | 30 | Good | Good | Very good | Very good |
| 23 | Sn—10Ti | — | 55 | Good | Poor | Excellent | Good |
| 24 | Sn—40Ta | — | 30 | Poor | Good | Good | Very good |
| 25 | pure Sn | — | 30 | Good | Very good | Poor | Poor |

As is demonstrated in Table 7, samples satisfying all requirements herein (Samples Nos. 1 to 22) have satisfactory initial reflectivities, do not require so much laser power to create recording marks, and are satisfactory in corrosion resistance and surface roughness. In contrast, the sample of pure tin has poor corrosion resistance, has a large surface roughness, and lacks practical utility. A sample which contains an alloy element as specified herein but in a content exceeding the specified range (Sample No. 24) shows a low initial reflectivity. Even if containing a suitable amount of a specific alloy element, a sample having an excessively large thickness of the recording layer (Sample No. 23) requires a large laser power to create recording marks and is slightly unsuitable in practical utility.

### INDUSTRIAL APPLICABILITY

Recording layers for optical information storage media according to the present invention are usable not only in current optical information storage media such as CDs (compact discs) and DVDs (digital versatile discs), but also in next-generation optical information storage media such as HD DVDs and Blu-ray Discs. In particular, they can be advantageously used in write-once optical information storage media, particularly to optical information storage media using blue-violet laser.

1. A recording layer for optical information storage media to create recording marks upon irradiation with a laser beam,
the recording layer comprising a tin-based alloy comprising a total of 1.0 atomic percent to 15 atomic percent of at least one selected from the group consisting of neodymium (Nd), gadolinium (Gd), and lanthanum (La).

2. The recording layer for optical information storage media, according to claim 1, wherein the recording layer has a thickness in the range of 10 nm to 50 nm.

3. The recording layer for optical information storage media, according to claim 1, wherein the laser beam has a wavelength in the range of 380 nm to 450 nm.

4. An optical information storage medium comprising the recording layer for optical information storage media of claim 1.

5. A sputtering target for optical information storage media, the sputtering target comprising a tin-based alloy comprising a total of 1.0 atomic percent to 15 atomic percent of at least one selected from the group consisting of neodymium (Nd), gadolinium (Gd), and lanthanum (La).

6. A recording layer for optical information storage media to create recording marks upon irradiation with a laser beam,
the recording layer comprising a tin-based alloy comprising 1 atomic percent to 30 atomic percent of boron (B).

7. The recording layer for optical information storage media, according to claim 6, wherein the recording layer further comprises 50 atomic percent or less (exclusive of 0 atomic percent) of indium (In).

8. The recording layer for optical information storage media, according to claim 6, wherein the recording layer further comprises a total of 15 atomic percent or less (exclusive of 0 atomic percent) of at least one selected from the group consisting of yttrium (Y), lanthanum (La), neodymium (Nd), and gadolinium (Gd).

9. The recording layer for optical information storage media, according to claim 6, wherein the laser beam has a wavelength in the range of 380 nm to 450 nm.

10. An optical information storage medium, comprising the recording layer for optical information storage media of claim 6.

11. A sputtering target for optical information storage media, the sputtering target comprising a tin-based alloy comprising 1 atomic percent to 30 atomic percent of boron (B).

12. The sputtering target for optical information storage media, according to claim 11, further comprising 50 atomic percent or less (exclusive of 0 atomic percent) of indium (In).

13. The sputtering target for optical information storage media, according to claim 11, further comprising a total of 15 atomic percent or less (exclusive of 0 atomic percent) of at least one selected from the group consisting of yttrium (Y), lanthanum (La), neodymium (Nd), and gadolinium (Gd).

14. A recording layer for optical information storage media to create recording marks upon irradiation with a laser beam,
the recording layer comprising a tin-based alloy comprising a total of 1 atomic percent to 50 atomic percent of nickel (Ni) and/or cobalt (Co).

15. The recording layer according to claim 14, wherein the tin-based alloy constituting the recording layer further comprises a total of 30 atomic percent or less (exclusive of 0 atomic percent) of at least one selected from the group consisting of indium (In), bismuth (Bi), and zinc (Zn).

16. The recording layer according to claim 14, wherein the tin-based alloy constituting the recording layer further comprises, as additional element(s), a total of 10 atomic percent or less (exclusive of 0 atomic percent) of at least one rare-earth element.

17. The recording layer according to claim 14, wherein the recording layer creates recording marks thereon upon irradiation with a laser beam having a wavelength of 350 nm to 700 nm.

18. An optical information storage medium, comprising the recording layer of claim 14.

19. The optical information storage medium according to claim 18, further comprising at least one of an optical control layer and a dielectric layer as an upper layer and/or an underlayer of the recording layer.

20. The optical information storage medium according to claim 18, wherein the recording layer has a thickness of 1 to 50 nm.

21. A sputtering target for the deposition of a recording layer of an optical information storage medium, the sputtering target comprising a tin-based alloy comprising a total of 1 atomic percent to 50 atomic percent of nickel (Ni) and/or cobalt (Co).

22. The sputtering target according to claim 21, wherein the tin-based alloy further comprises, as additional element(s), a total of 30 atomic percent or less (exclusive of 0 atomic percent) of at least one selected from the group consisting of indium (In), bismuth (Bi), and zinc (Zn).

23. The sputtering target according to claim 21, wherein the tin-based alloy further comprises, as additional element(s), a total of 10 atomic percent or less (exclusive of 0 atomic percent) of at least one rare-earth element.

24. An optical information storage medium comprising a substrate and a recording layer to create recording marks upon irradiation with a laser beam, wherein the recording layer comprises a tin-based alloy comprising 1 atomic percent to 15 atomic percent of at least one rare-earth element, and wherein the optical information storage medium further comprises a protective layer adjacent to a side of the recording layer facing the substrate and/or adjacent to the other side of the recording layer opposite to the substrate.

25. The optical information storage medium according to claim 24, wherein the tin-based alloy further comprises, as additional element(s), a total of 50 atomic percent or less (exclusive of 0 atomic percent) of indium (In) and/or bismuth (Bi).

26. The optical information storage medium according to claim 24, wherein the recording layer has a thickness of 1 to 50 nm.

27. The optical information storage medium according to claim 24, wherein the recording layer creates recording marks thereon upon irradiation with a laser beam having a wavelength of 350 nm to 700 nm.

28. A sputtering target for the deposition of a recording layer of an optical information storage medium, the sputtering target comprising a tin-based alloy comprising a total of 1 atomic percent to 15 atomic percent of at least one rare-earth element.

29. The sputtering target according to claim 28, wherein the tin-based alloy further comprises, as additional element(s), a total of 50 atomic percent or less of indium (In) and/or bismuth (Bi).

30. A recording layer for optical information storage media to create recording marks upon irradiation with a laser beam, the recording layer comprising a tin-based alloy comprising a total of 2 atomic percent to 30 atomic percent of at least one element selected from the group consisting of elements belonging to Groups 4a, 5a, 6a, and 7a of the Periodic Table of Elements, and platinum (Pt), dysprosium (Dy), samarium (Sm), and cerium (Ce).

31. The recording layer according to claim 30, wherein the tin-based alloy constituting the recording layer further comprises a total of 10 atomic percent or less (exclusive of 0 atomic percent) of neodymium (Nd) and/or yttrium (Y).

32. The recording layer according to claim 30, wherein the recording layer creates recording marks thereon upon irradiation with a laser beam having a wavelength of 350 nm to 700 nm.

33. An optical information storage medium, comprising the recording layer of claim 30.

34. The optical information storage medium according to claim 33, further comprising at least one of an optical control layer and a dielectric layer as an upper layer and/or an underlayer of the recording layer.

35. The optical information storage medium according to claim 33, wherein the recording layer has a thickness of 1 to 50 nm.

36. A sputtering target for the deposition of a recording layer of an optical information storage medium, the sputtering target comprising a tin-based alloy comprising a total of 2 atomic percent to 30 atomic percent of at least one selected from the group consisting of elements belonging to Groups 4a, 5a, 6a, and 7a of the Periodic Table of Elements, and platinum (Pt), dysprosium (Dy), samarium (Sm), and cerium (Ce).

37. The sputtering target according to claim 36, wherein the tin-based alloy further comprises, as additional element(s), a total of 10 atomic percent or less (exclusive of 0 atomic percent) of neodymium (Nd) and/or yttrium (Y).
